(19) United States
(12) Patent Application Publication
(10) Pub. No.: US 2015/0332660 A1
(43) Pub. Date: Nov. 19, 2015

(54) Musical Instrument and Method of Controlling the Instrument and Accessories Using Control Surface

(71) Applicant: Fender Musical Instruments Corporation, Scottsdale, AZ (US)

(72) Inventors: Charles C. Adams, Gilbert, AZ (US); Keith L. Chapman, Fountain Hills, AZ (US)

(73) Assignee: Fender Musical Instruments Corporation, Scottsdale, AZ (US)

(21) Appl. No.: 14/279,231

(22) Filed: May 15, 2014

(51) Int. Cl. G10H 1/00

(52) U.S. Cl. CPC G10H 1/0066

(57) ABSTRACT

A guitar has a control system with a control surface disposed over the guitar and connected to the control system. A gesture is performed over the control surface. The gesture is created by user interaction with the control surface, such as movement of one or more fingers. The operation of the control surface is selectable and generates electrical signals representative of the gesture. An audio signal generated by the guitar is modified in response to the control signal. A musical accessory, e.g., an amplifier, effects box, synthesizer, special effects, or speaker is coupled to the guitar. The control signal is sent to the accessory to modify and control properties of the accessory. A configuration of the accessory and a configuration of the guitar are modified in response to the control signal. The control system is programmed to output the control signal over a wireless network.

### FIELD OF THE INVENTION

The present invention relates in general to musical instruments and, more particularly, to a musical instrument and method of controlling the instrument and accessories using a motion-sensitive control surface.

### BACKGROUND OF THE INVENTION

Musical instruments have always been popular in society providing entertainment, social interaction, self-expression, and a source of livelihood for many people. Musical instruments and related accessories are used by professional and amateur musicians to generate, alter, transmit, and reproduce audio signals. The audio signal from the musical instrument is typically an analog signal containing a progression of values within a continuous range. The audio signal can also be digital in nature containing a series of binary one and zero values.

Guitars are one type of musical instrument used by both amateur and professional musicians. A guitar is played by displacing one or more of the tightly strung strings from a neutral position, causing the string to vibrate as the string returns to the neutral position. In the case of an electric guitar, pickups are attached beneath the guitar strings to generate or modulate an electrical signal in response to the movement of the strings. The electrical signals are routed from the guitar to external equipment, for example, an amplifier and speaker, for reproduction of the sound corresponding to the vibrating strings.

Guitars and other musical instruments are often used in conjunction with related musical accessories, such as microphones, audio amplifiers, speakers, mixers, synthesizers, samplers, effects pedals, public address systems, digital recorders, and other similar devices. The devices are used to control, capture, alter, combine, store, and play back the audio signals originating from the instrument. Guitars and related accessories include hand-operated controls located on a surface or front panel of the guitar or accessory. For example, an electric guitar has control switches that select one or more pickups as the source of the audio signal, and control knobs that determine the volume and tonal qualities of the audio signal output from the guitar. An audio amplifier has control knobs, buttons, sliders, and switches for amplification, volume, gain, filtering, tone equalization, sound effects, bass, treble, midrange, reverb dwell, reverb mix, vibrato speed, and vibrato intensity. A multi-channel mixer has controls for each input channel, as well as additional master controls that affect each channel. An effects box has controls for adding distortion, dynamics, filter, pitch/frequency, time-based, feedback/sustain, or other effects to an audio signal.

The audio signal output from the guitar and related accessories is controlled and manipulated by moving the various mechanical interfaces, e.g., switches, knobs, buttons, foot pedals, and sliders, to the desired setting. In many cases, one mechanical interface controls one system setting. A knob controls volume of the audio amplifier, a switch controls the pickup, a button controls the synthesizer, a foot pedal selects the effect, a slider controls the bass, and so on. Setting, adjusting, and coordinating all the mechanical interfaces to control the guitar and various external equipment and accessories is a time consuming task and often involves adjustment of the controls during a performance. The guitarist has to take time away from the actual playing of the guitar to adjust the controls on the guitar, equipment, and accessories. During a live performance, the equipment and accessories can be located at various positions on a stage. The distance between the accessories prevents the guitarist from adjusting and configuring all the accessories in quick succession and generally makes it difficult to control the entire system. Waiting for a guitarist to adjust the mechanical interfaces on the guitar, audio amplifier, synthesizer, effects box, and speaker detracts from the performance.

### SUMMARY OF THE INVENTION

A need exists to allow a musician to modify audio signals and control accessories from a guitar. Accordingly, in one embodiment, the present invention is a method of configuring and controlling a musical instrument comprising the steps of providing a guitar, disposing a control surface over the guitar, performing a gesture with respect to the control surface, creating a control signal in response to the gesture, and modifying an audio signal generated by the guitar in response to the control signal.

In another embodiment, the present invention is a method of configuring and controlling a musical instrument comprising the steps of providing a first musical instrument including a control surface, providing user interaction as gestures into the control surface, and creating a control signal in response to the user interaction.

In another embodiment, the present invention is a musical instrument comprising a stringed instrument including a control surface. A control system is connected to the control surface of the stringed instrument responsive to gestures performed with respect to the control surface.

In another embodiment, the present invention is a musical instrument comprising a control system coupled to a control surface of the musical instrument and responsive to a gesture performed with respect to the control surface.

### BRIEF DESCRIPTION OF THE DRAWINGS

FIG. 1 illustrates a guitar including a motion-sensitive control surface;

FIGS. 2a-2b illustrate user interaction with the motion-sensitive control surface on the guitar;

FIGS. 3a-3g illustrate a plurality of gestures performed over a motion-sensitive control surface on the guitar;

FIGS. 4a-4d illustrate a guitar with motion-sensitive control surfaces coupled to a control system;

FIG. 5 illustrates a functional block diagram of a control system for controlling a musical instrument and accessories;

FIG. 6 illustrates changing xyz coordinates based on a gesture made by user interaction;

FIG. 7 illustrates a guitar with a motion-sensitive control surface and other musical instruments and related accessories connected through a communication network;

FIGS. 8a-8d illustrate a guitar with a control surface controlling musical instruments and related accessories; and

FIG. 9 illustrates a stage with special effects for arranging musical instruments and musical related accessories connected through a communication network.

### DETAILED DESCRIPTION OF THE DRAWINGS

The present invention is described in one or more embodiments in the following description with reference to the figures, in which like numerals represent the same or similar elements. While the invention is described in terms of the best mode for achieving objectives of the invention, those skilled in the art will appreciate that the disclosure is intended to cover alternatives, modifications, and equivalents as may be included within the spirit and scope of the invention as defined by the appended claims and claims equivalents as supported by the following disclosure and drawings.

Guitar playing involves displacing one or more tightly strung strings from a neutral position, causing the string to vibrate as the string returns to the neutral position. An electric guitar employs electromagnetic pickups and amplifiers to produce sound. The pickups are attached to the guitar and generate or modulate an electrical signal in response to the movement of the strings. The electrical signals extend over a range or spectrum of frequencies with an amplitude associated with each frequency component. Various signal processing and conditioning are typically performed on the audio signal. The audio signal from the guitar is transmitted through onboard equipment, e.g., pickups and internal circuitry, and through external accessories, e.g., amplifiers, speakers, mixers, synthesizers, effects pedals, and samplers, for signal processing and sound reproduction. The signal processing includes amplification, filtering, equalization, addition of sound effects, user-defined modules, and other signal processing functions, which adjust the power level and enhance the signal properties of the audio signal. While commonly used with electronic instruments, signal processing and conditioning can also be performed on audio signals from other musical instruments, equipment, and vocals. Modifying an audio signal by adding distortion, dynamics, filter, pitch/frequency, time-based, feedback/sustain, or other effects allows a guitarist or other musician to create a custom sound during live performances and in studio.

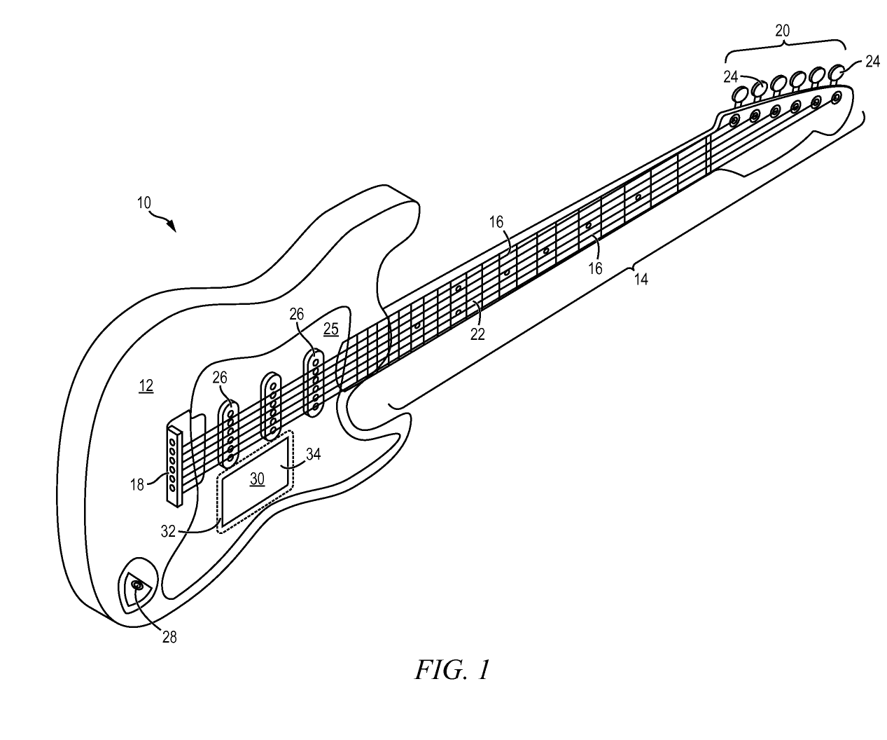

FIG. 1 shows an electric guitar 10 including body 12, neck 14, and strings 16. A bridge 18 is affixed to body 12 using adhesive, screws, clips, or other suitable attachment mechanism. Bridge 18 anchors and supports one end of strings 16. Neck 14 of electric guitar 10 includes headstock 20 and fretboard 22. Machine heads 24 are attached to headstock 20 and anchor an opposite end of strings 16. The tension of strings 16 is adjusted and guitar 10 is tuned by turning machine heads 24. A pickguard or scratch plate 25 is attached to body 12. Pickguard 25 protects guitar 10 from damage or marking by a guitar pick during play. Pickguard 25 can be plastic, acrylic glass, polyvinyl chloride, glass, plywood, fabric, metal, animal skin, nacre, or other suitable protective material. Pickguard 25 is mounted to body 12 using adhesive, screws, clips, or other suitable attachment mechanism. Pickguard 25 can be cut or molded to any shape to be both functional and aesthetic. The internal circuitry and other functional aspects of guitar 10 can be accessed by removing pickguard 25.

Pickups 26 are mounted to body 12 using adhesive, screws, clips, or other suitable attachment mechanism. Pickups 26 are disposed under strings 16. Pickups 26 convert string movement to electrical signals representative of the intended sounds from the vibrating strings. An audio output jack 28 is affixed to body 12. The electrical signals generated by pickups 26 are output from guitar 10 through audio output jack 28. The audio signals and control signals are routed from audio output jack 28 to external devices, e.g., an amplifier and speaker, for signal conditioning and sound reproduction.

A touchpad 30 is attached to pickguard 25 using screws, adhesive, clips, friction coupling, or other suitable attachment mechanism. Alternatively, touchpad 30 can be attached directly to body 12. Touchpad 30 is located proximate to strings 16 or to the position of the hand during the playing operation of the guitar. Touchpad 30 could also be disposed between bridge 18 and a distal edge of body 12. The location of touchpad 30 is selected to allow a guitarist quick, easy, and ergonomic access to the touchpad while strumming strings 16, or with a relatively short interruption from the strumming action in a manner that avoids breaking the rhythm of playing.

Touchpad 30 is a motion-sensitive control surface for sensing or detecting user interaction by contact or motion, e.g., fingers moving on or over the touchpad, and provides sensing signals to user interaction control system (UICS) 32, which is incorporated into guitar 10, e.g., within body 12 behind pickguard 25. Alternatively, UICS 32 can be located in other areas within body 12 or over guitar 10 away from touchpad 30. UICS 32 operates in response to the sensing signals from touchpad 30 and interprets the totality of the contact or motion as a gesture to provide instructions to enable a number of signal processing capabilities and other control functions associated with guitar 10, as well as external equipment used with guitar 10. The gesture can be any body movement (hand, finger, arm, leg, foot, head, etc.) intended for virtual control of guitar 10. UICS 32 sends control signals to internal circuitry of guitar 10. The control signals modify and control the audio signal prior to the audio signal being output from audio output jack 28. For example, UICS 32 sends a control signal causing a particular set of pickups 26 on guitar 10 to be selected or UICS 32 sends a control signal causing a signal processing unit onboard guitar 10 to add a sound effect, e.g., delay, to the audio signal generated by pickups 26. Alternatively, UICS 32 communicates via output jack 28 to control external amplifiers and other equipment to modify the audio signal or otherwise control the equipment.

Touchpad 30 is connected to UICS 32 to allow a guitarist to input commands to guitar 10 and external equipment via contact and motion with respect to the touchpad. Touchpad 30 is capable of detecting a presence and location of multiple points of contact or motion. Touchpad 30 detects the location of points of contact along an x-axis extending horizontally across the touchpad, along a y-axis extending vertically across the touchpad normal to the x-axis, and in a z-axis extending orthogonal from surface 34 of the touchpad. Touchpad 30 is configured to detect multiple types of user interaction, e.g., contacting surface 34 as well as sensing actions performed above surface 34. Touchpad 30 distinguishes points of contact and motion as gestures based on changing locations in the x-axis, y-axis, and z-axis associated with coordinated movement of the fingers, hand, guitar pick, or pick with sensor.

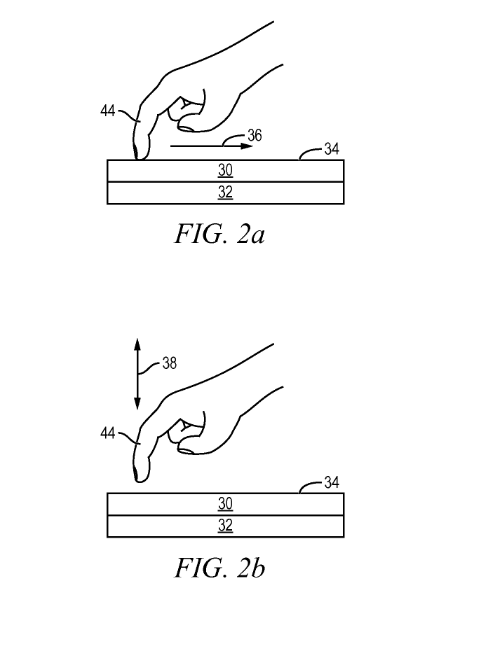

FIG. 2a shows finger 44 contacting surface 34 of touchpad 30 and moving in the direction of arrow 36. The motion of finger 44 along surface 34 creates multiple points of contact in the x-axis and y-axis of the surface over time. Touchpad 30 also senses and distinguishes motion in the z-axis based on proximity to surface 34 or an amount of pressure applied to the touchpad. FIG. 2b shows finger 44 positioned above and proximate to surface 34 of touchpad 30 and moving along the z-axis perpendicular to surface 34, as shown by the direction of arrow 38. Touchpad 30 can detect hand or finger motion along, above, or moving toward or away from surface 34. The multiple points of contact or motion in the x-axis, y-axis, and z-axis provides a set of xyz coordinates with respect to surface 34, which collectively constitutes a gesture, such as a sliding motion in the direction of arrow 36 across surface 34.

In another embodiment, the user movements or interaction can be detected some distance away from the control surface by using optical sensing or laser pointer.

Touchpad 30 employs capacitive, resistive, optical, laser, wave, force sensing, electromagnetic, or other suitable motion detection technology to detect and distinguish points of contact or motion on or above surface 34 by user interaction. The plural-point and z-axis awareness of touchpad 30 allows for detecting and distinguishing between a plurality of gestures. UICS 32 assigns a unique control signal to each gesture or combination of gestures detected by touchpad 30. A guitarist controls aspects of guitar 10 and accessories associated with the guitar by performing gestures on or over touchpad 30.

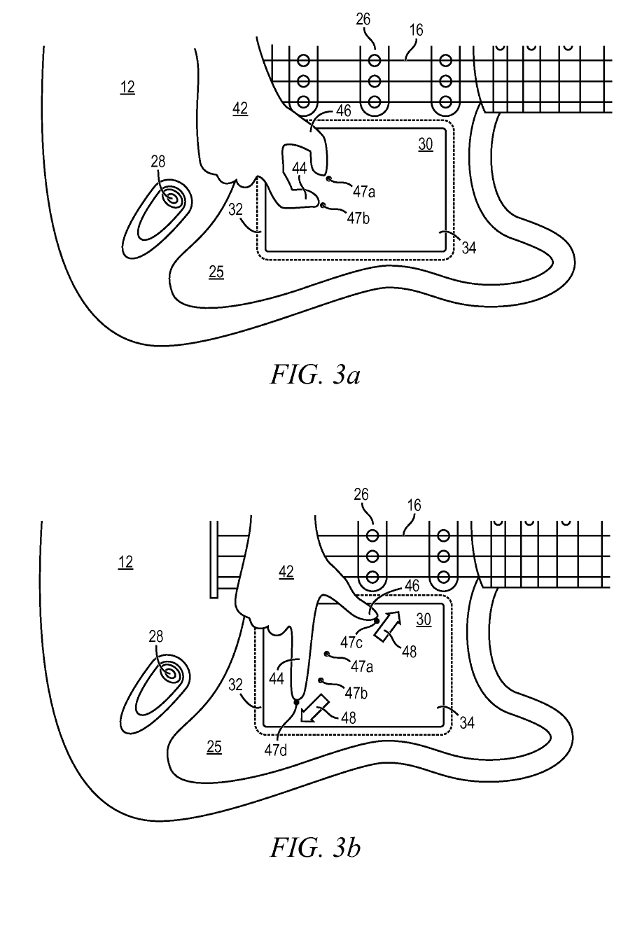

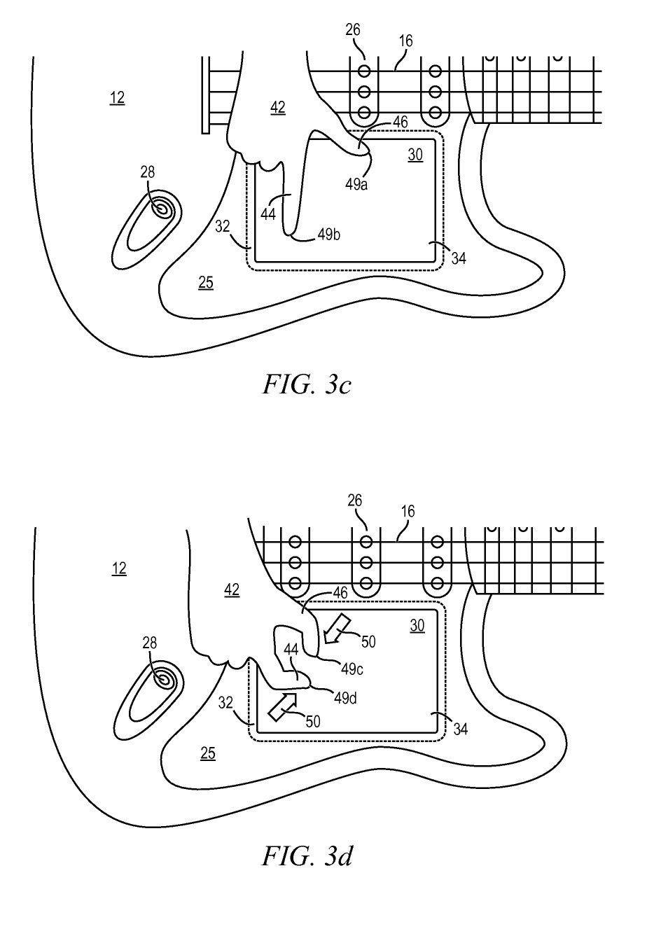

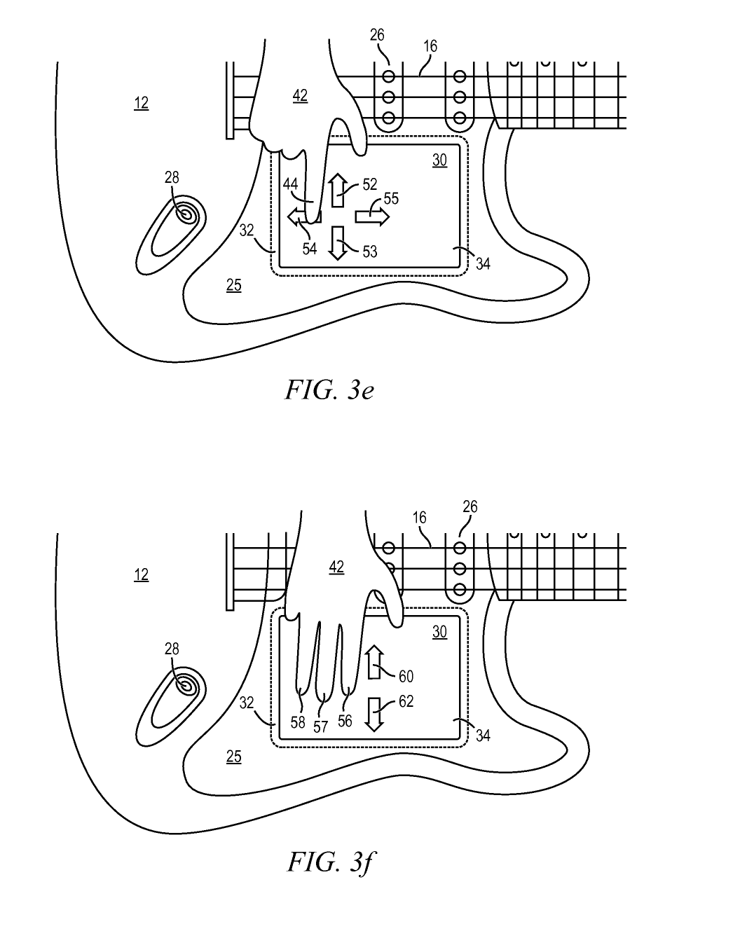

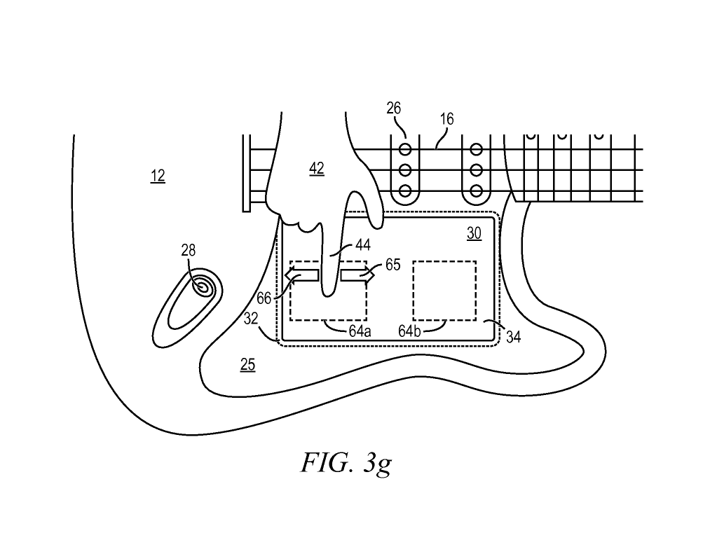

FIGS. 3a-3g illustrate examples of gestures that can be performed on touchpad 30. FIG. 3a shows hand 42 in an initial stage of a pinch-open gesture on surface 34 of touchpad 30. Fingers 44 and 46 on hand 42 begin close together. Touchpad 30 detects the initial two points of contact 47a-47b made by fingers 44 and 46 with respect to surface 34, each with an initial x-direction, y-direction, z-direction (xyz) coordinate relative to touchpad 30. The x-direction and y-direction are oriented along surface 34, perpendicular to each other, and the z-direction is normal to surface 34. FIG. 3b shows the final stage of the pinch-open gesture with fingers 44 and 46 spread apart in the direction of arrows 48 to end points 47c-47d. The movement of fingers 44-46 along surface 34 in the pinch-open gesture in the direction of arrows 48 creates multiple xyz coordinates over time. The set of xyz coordinates from points 47a-47b to 47c-47d and other points in-between define the total movement involved in the pinch-open gesture.

Touchpad 30 can detect any position, gesture, motion, or sequence of movements of the fingers or hand based on the dynamically changing xyz coordinates, velocity based on changes in distance between xyz coordinates over time, and acceleration as the rate of change in velocity. In response to the pinch-open gesture, UICS 32 issues the control signal assigned to a pinch-open gesture. For example, UICS 32 is programmed to increase volume during a pinch-open gesture. When the user performs a pinch-open gesture, the increase volume control signal is sent to the audio amplifier and the volume associated with the audio signal of guitar 10 is increased.

FIG. 3c shows hand 42 performing a pinch-close gesture on surface 34 of touchpad 30 with fingers 44 and 46 initially spread apart. Touchpad 30 detects the initial two points of contact 49a-49b made by fingers 44 and 46 with respect to surface 34 each with an initial xyz coordinate relative to the touchpad. FIG. 3d shows the final stage of the pinch-close gesture with fingers 44 and 46 closer together in the direction of arrows 50 at end points 49c-49d. The movement of fingers 44-46 along surface 34 in the pinch-close gesture in the direction of arrows 50 creates multiple xyz coordinates over time. The set of xyz coordinates from points 49a-49b to 49c-49d and other points in-between define the total movement involved in the pinch-close gesture.

Touchpad 30 can detect any position, gesture, motion, or sequence of movement of the fingers and hand based on the dynamically changing xyz coordinates, velocity based on changes in distance between xyz coordinates over time, and acceleration as the rate of change in velocity. In response to the pinch-close gesture, UICS 32 issues the control signal assigned to a pinch-close gesture. For example, UICS 32 is programmed to decrease volume during a pinch-close gesture. When the user performs a pinch-close gesture, the decrease volume control signal is sent to the audio amplifier and the volume associated with the audio signal of guitar 10 is decreased.

FIG. 3e shows hand 42 performing a one-finger slide gesture on surface 34 of touchpad 30. Finger 44 makes initial contact with surface 34 and then moves along surface 34 in a direction of arrow 52 or arrow 53 or arrow 54 or arrow 55. Arrows 52-55 can be any orientation with respect to the x-axis and y-axis of touchpad 30. Touchpad 30 detects the initial xyz coordinates of finger 44 on surface 34 and then detects continuously changing xyz coordinates over time as the finger moves across surface 34 during the one-finger slide gesture in a particular direction, i.e., in the direction of one of arrows 52-55. Upon recognition of the one-finger slide in the direction of arrow 52, UICS 32 sends the control signal assigned to a one-finger slide in the direction of arrow 52. Alternatively, upon recognition of the one-finger slide in the direction of arrow 53, UICS 32 sends the control signal assigned to a one-finger slide in the direction of arrow 53. For example, UICS 32 is programmed to increase bass upon recognition of the one-finger slide in the direction of arrow 52, and decrease bass upon recognition of the one-finger slide in the direction of arrow 53.

FIG. 3f shows hand 42 performing a three-finger slide on surface 34 of touchpad 30. Fingers 56, 57, and 58 make initial contact with surface 34 and then move along surface 34 in a direction of arrow 60 or arrow 62. Touchpad 30 detects the initial xyz coordinates of fingers 56-58 on surface 34 and then detects continuously changing xyz coordinates over time as the fingers move across surface 34 during the three-finger slide gesture in a particular direction, i.e., in the direction of arrow 60 or arrow 62. Upon recognition of the three-finger slide in the direction of arrow 60, UICS 32 issues the control signal assigned to a three-finger slide in the direction of arrow 60. Upon recognition of the three-finger slide in the direction of arrow 62, UICS 32 issues the control signal assigned to a three-finger slide in the direction of arrow 62. For example, UICS 32 is programmed to increase add reverb upon recognition of the three-finger slide in the direction of arrow 60, and remove reverb upon recognition of the three-finger slide in the direction of arrow 62.

Touchpad 30 includes region sensitivity to distinguish a gesture performed in one region of surface 34 from a gesture performed in a different region of surface 34. FIG. 3g shows hand 42 performing a one-finger slide gesture over a region 64a of surface 34. Finger 44 makes initial contact with surface 34 in region 64a and then moves along surface 34 in a direction of arrow 65 or arrow 66. Touchpad 30 detects that xyz coordinates of contact made by finger 44 is in region 64a, and further detects the direction of movement of the finger on surface 34. Touchpad 30 senses hand 42 performing a one-finger slide, similar to FIG. 3e, in the direction of arrow 65 or arrow 66 over region 64a. Upon recognition of the one-finger slide gesture in the direction of arrow 65 over region 64a, UICS 32 sends the control signal assigned to a one-finger slide in the direction of arrow 65 over region 64a, e.g., enable special effect lighting 230. Upon recognition of a one-finger slide gesture in the direction of arrow 66 in region 64a, UICS 32 sends the control signal assigned to the one-finger slide in the direction of arrow 66 over region 64a, e.g., disable special effect lighting 230.

Touchpad 30 distinguishes a gesture performed in region 64b of surface 34 from the same gesture performed in region 64a of surface 34. For example, touchpad 30 is configured to distinguish a one-finger slide in a direction of arrow 65 performed in region 64a from a one-finger slide in the direction of arrow 65 performed in region 64b. Upon recognition of the one-finger slide gesture in the direction of arrow 65 over region 64b, UICS 32 sends the control signal assigned to a one-finger slide in the direction of arrow 65 over region 64b, e.g., activate fog machine 232. Upon recognition of a one-finger slide gesture in the direction of arrow 66 in region 64b, UICS 32 sends the control signal assigned to the one-finger slide in the direction of arrow 66 over region 64b, e.g., deactivate fog machine 232.

In addition to the gestures shown in FIGS. 3a-3g, touchpad 30 detects and distinguishes tap, double-tap, drag, flick, rotate, circular, oval, arc, triangle, square, hover, moving-hover, or any other distinguishable gesture performed on or over surface 34 by user interaction via the hand, finger, or any object held by the user such as a guitar pick or pick with laser. The set of xyz coordinates, initial contact points, intermediate coordinates, and final contact points define the total movement involved by the gesture. Touchpad 30 can detect any position, gesture, motion, or sequence of movement of fingers and hand based on the dynamically changing xyz coordinates, velocity based on changes in distance between xyz coordinates over time, and acceleration as the rate of change in velocity. The control signals assigned to each gesture and each region of surface 34 are customizable using software operating on an external device, e.g., a personal computer (PC) or tablet, or using software provided within UICS 32. UICS 32 can be programmed to assign control signals to any number, combination, or sequence of gestures performed on or over surface 34. The individual gestures can be readily reassigned to different control functions by the user.

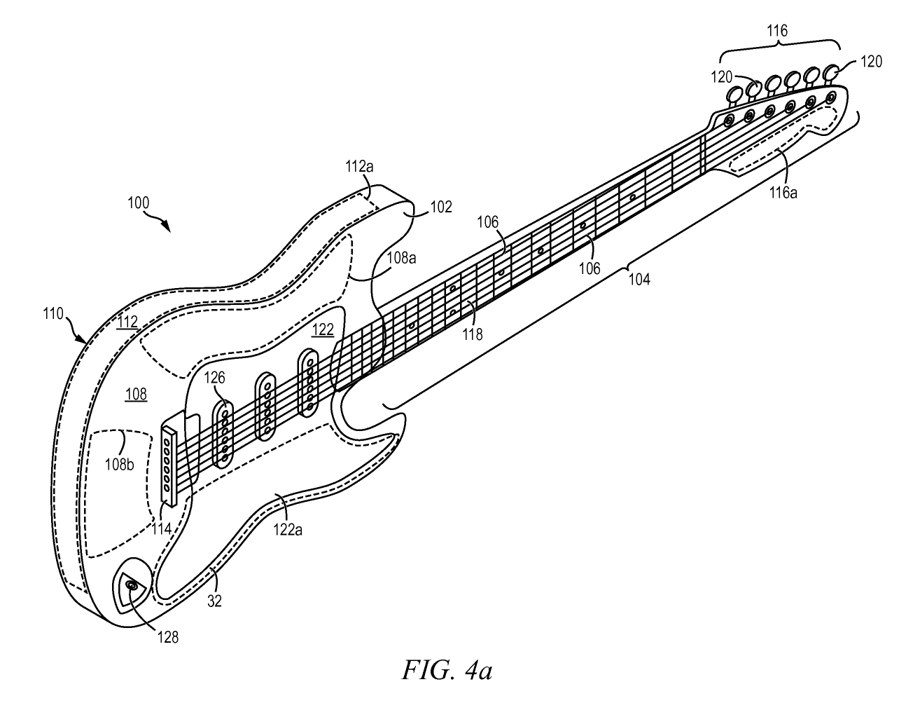

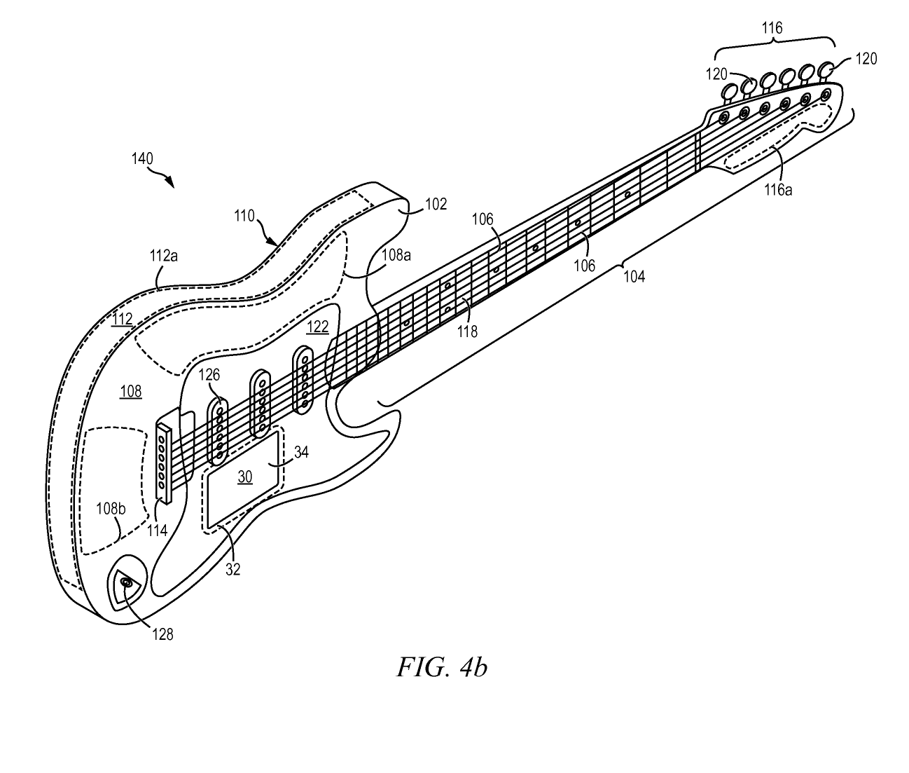

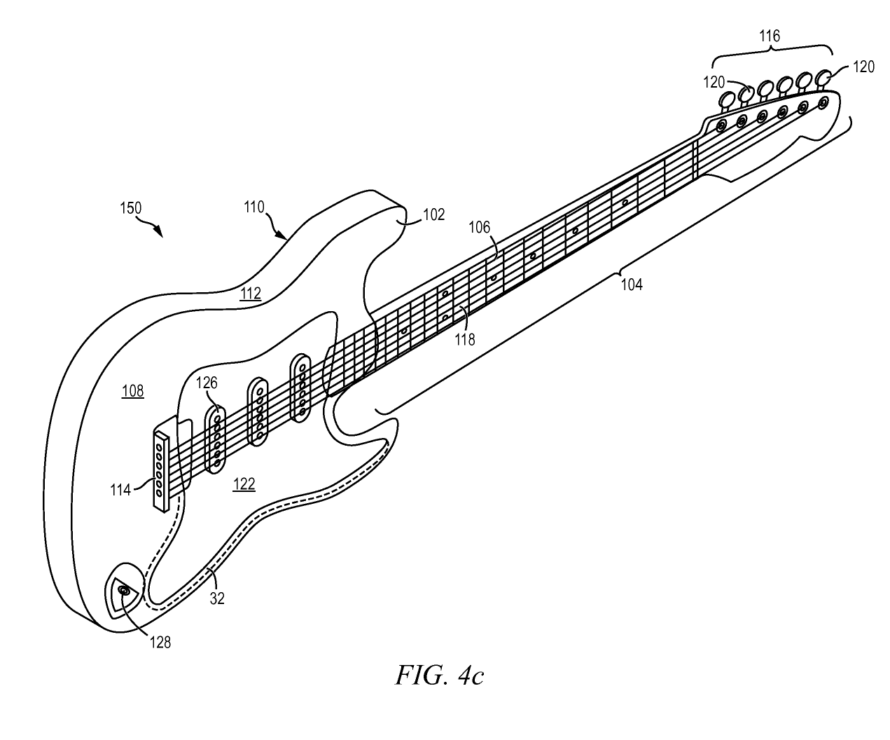

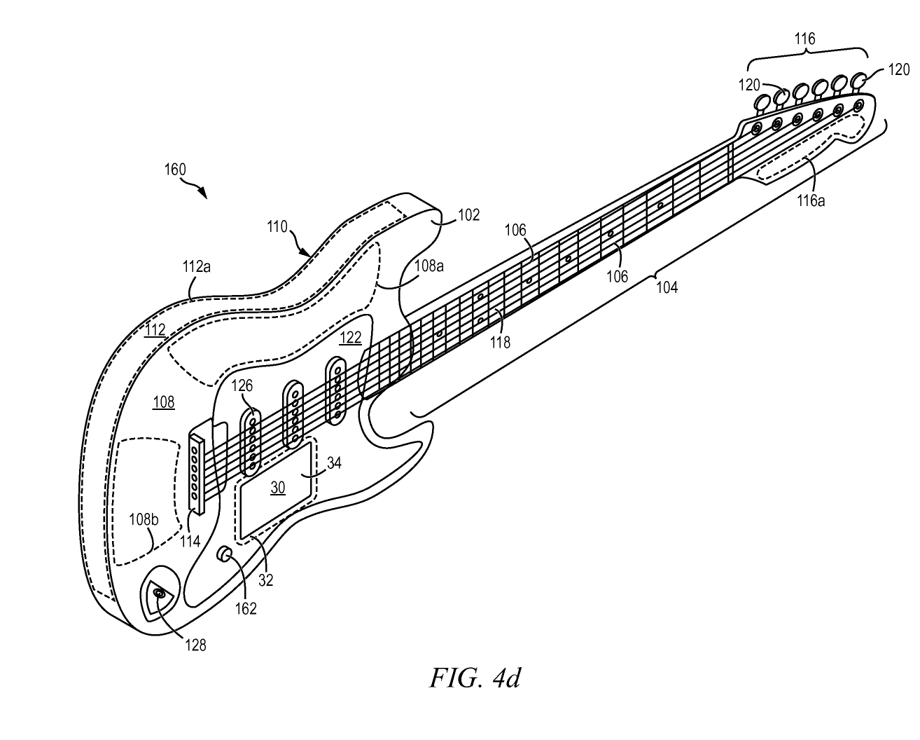

FIGS. 4a-4d illustrate a guitar with touch-sensitive, motion-sensitive, or other user interactive control surfaces coupled to a control system. FIG. 4a shows a guitar 100 with multiple motion-sensitive control surfaces. Guitar 100 includes a body 102, neck 104, and strings 106. Body 102 has opposing surfaces 108 and 110 and side surface 112. A bridge 114 is affixed to surface 108 of body 102 using adhesive, screws, clips, or other suitable attachment mechanism. Bridge 114 anchors and supports one end of strings 106. Neck 104 of guitar 100 includes headstock 116 and fretboard 118. Machine heads 120 are attached to headstock 116 and anchor strings 106. Machine heads 120 are turned to adjust the tension of strings 106 and tune guitar 100.

A pickguard or scratch plate 122 is attached to surface 108 of body 102. Pickguard 122 protects surface 108 from being scratched or marred by a guitar pick. Pickguard 122 is mounted to body 102 using adhesive, screws, clips, or other suitable attachment mechanism. Pickguard 122 can be cut or molded to any shape to be both functional and aesthetic. Control circuitry of guitar 100 is disposed under pickguard 122 and can be accessed by removing the pickguard.

Pickups 126 are mounted to surface 108 using adhesive, screws, clips, or other suitable attachment mechanism. Pickups 126 are disposed under strings 106. Pickups 126 convert string movement to electrical signals representative of the intended sounds from the vibrating strings. Body 102 includes an audio output jack 128. An audio signal is output from guitar 100 through audio output jack 128. The audio signals are routed from audio output jack 128 to external devices, for example, amplifiers, effects boxes, and speakers, for additional signal conditioning and sound reproduction.

A plurality of control surfaces or regions is formed over guitar 100. Surface 108 of body 102 includes control regions 108a and 108b. Control region 108a is formed extending along a portion of surface 108 above pickguard 122. Control region 108b is formed extending along a distal portion of surface 108 opposite neck 104 and adjacent to bridge 114. Control regions 108a and 108b can be configured to any shape and extends along any portion of surface 108. Any region of surface 108 can be made motion-sensitive. In one embodiment, the entire surface 108 of body 102 is motion-sensitive.

Control regions 108a and 108b are configured to detect a presence and location of multiple points of contact or motion, similar to FIGS. 3a-3g. Control regions 108a and 108b detect the location of points of contact along an x-axis extending horizontally across the control regions, along a y-axis extending vertically across the control regions normal to the x-axis, and in a z-axis extending orthogonally from surface 108. Control regions 108a and 108b sense and distinguish points of contact in the z-axis based on an amount of pressure applied to surface 108. Control regions 108a and 108b also sense and distinguish motion in the z-axis based on proximity to surface 108. Control regions 108a and 108b detect when a finger or guitar pick is contacting surface 108 and sense how much pressure is being applied to surface 108. Control regions 108a and 108b also detect when a finger is hovering above, moving toward, or moving away from surface 108. Control regions 108a and 108b employ capacitive, resistive, optical, laser, wave, force sensing, electromagnetic, or other suitable motion detection technology to detect and distinguish points of contact or motion on or above surface 108. The plural-point and z-axis awareness of control regions 108a and 108b allow the control regions to detect and distinguish between a plurality of gestures.

Surface 112 of body 102 includes a control region 112a. Control region 112a is formed along a portion of surface 112 that is proximate to a person playing guitar 100 and extends along surface 112 over a distal end of guitar 100. Control region 112a can be formed over any portion of surface 112. Surface 112 includes multiple distinct control regions or entire surface 112 is motion-sensitive. In one embodiment, the entire surface 112 of body 102 is motion-sensitive.

Control region 112a is capable of detecting a presence and location of multiple points of contact or motion. Control surface 112a detects the location of points of contact along an x-axis extending horizontally across surface 112a, along a y-axis extending vertically across the control surface normal to the x-axis, and in a z-axis extending orthogonally from the control surface. Control surface 112a senses and distinguishes points of contact in the z-axis based on an amount of pressure applied to surface 112. Control surface 112a also senses and distinguishes motion in the z-axis based on proximity to surface 112. Control surface 112a detects when a finger or guitar pick is contacting surface 112a and senses how much pressure is being applied to surface 112a by the finger. Control surface 112a also detects when a finger is hovering above, moving toward, or moving away from surface 112a. Control surface 112a employs capacitive, resistive, optical, laser, wave, force sensing, electromagnetic, or other suitable motion detection technology to detect and distinguish points of contact or motion on or above surface 112a. The plural-point and z-axis awareness of control surface 112a allows surface 112a to detect and distinguish between a plurality of gestures.

Headstock 116 includes a control region 116a. Control region 116a is formed below strings 106, over a portion of headstock 116 distal to machine heads 120. Pickguard 122 includes a control region 122a. Control region 122a is formed below strings 106. Any surface of headstock 116 and/or pickguard 122 can be made a control surface. In one embodiment, the surface of headstock 116 opposite strings 106 is a control surface.

Control regions 116a and 122a are capable of detecting a presence and location of multiple points of contact or motion. Control surfaces 116a and 122a detect the location of points of contact along an x-axis extending horizontally across the control surface, along a y-axis extending vertically across the control surface normal to the x-axis, and in a z-axis extending orthogonally from the control surface. Control surfaces 116a and 122a sense and distinguish points of contact in the z-axis based on an amount of pressure applied to the control surface. Control surfaces 116a and 122a also sense and distinguish motion in the z-axis based on proximity to the control surface. Control surfaces 116a and 122a detect when a finger or guitar pick is contacting the control surface and sense how much pressure is being applied to the surface by the finger. Control surfaces 116a and 122a also detect when a finger is hovering above, moving toward, or moving away from the control surface. Control surfaces 116a and 122a employ capacitive, resistive, optical, laser, wave, force sensing, electromagnetic, or other suitable motion detection technology to detect and distinguish points of contact or motion on or above the control surface. The plural-point and z-axis awareness of control surfaces 116a and 122a allow surfaces 116a and 122a to detect and distinguish between a plurality of gestures.

Motion-sensitive control surfaces 108a, 108b, 112a, 116a, and 122a are connected to UICS 32. Control surfaces 108a, 108b, 112a, 116a, and 122a are used to input commands into UICS 32. A guitarist inputs commands into UICS 32 by performing gestures on or over control surfaces 108a, 108b, 112a, 116a, and 122a. UICS 32 sends control signals to internal circuitry of guitar 100 or external devices coupled to guitar 100 in response to gestures performed on or over control surfaces 108a, 108b, 112a, 116a, and 122a. Control surfaces 108a, 108b, 112a, 116a, and 122a are configured to detect and distinguish between a plurality of gestures, e.g., a tap, double tap, one-finger slide, three-finger slide, hover, or other recognizable gesture made by user interaction via the hand, finger, or any object held by the user such as a guitar pick. UICS 32 recognizes a gesture performed over one control surface of guitar 100 from the same gesture performed over a different control surface of guitar 100. UICS 32 assigns a unique control signal to each gesture or combination of gestures performed over one or more control surfaces. For example, the control signal sent in response to a double tap on control surface 108b is different from the control signal sent in response to a double tap on control surface 116a. The control signal sent in response to a three-finger slide on control surface 108b is different from the control signal sent in response to a one-finger slide on control surface 108b.

UICS 32 and control surfaces 108a, 108b, 112a, 116a, and 122a provide a number of signal processing capabilities and other functions useful with guitar 100, as well as external equipment associated with guitar 100. UICS 32 lets the guitarist modify and control the audio signal using control surfaces 108a, 108b, 112a, 116a, and 122a. The guitarist can control amplifiers, speakers, effects boxes, mixers, microphones, stage lighting, fog machines, lasers, props, or other external accessories using control surfaces 108a, 108b, 112a, 116a, and 122a. UICS 32 outputs a control signal in response to each gesture or combination of gestures performed over one or more control surfaces of guitar 100. A particular device can be assigned to a particular control surface. For example, gestures performed on control surface 108a cause control signals to be sent to an effects box, gestures performed on control surface 108b cause control signals to be sent to an amplifier, and gestures performed on control surface 112a cause control signals to be sent to stage lights.

Guitar 100 can include any number and/or configuration of control surfaces. In one embodiment, portions of surface 110 of body 102 are made motion-sensitive. Any non-playing surface can be made motion-sensitive. Any surface that does not need to be contacted during a normal playing of guitar 100 is a non-playing surface. The location of the control surfaces is selected to allow quick and easy access to the control surfaces while playing guitar 100.

FIG. 4b shows a guitar 140 similar to guitar 100 in FIG. 4a. Guitar 140 includes motion-sensitive control surfaces 30, 108a, 108b, 112a, and 116a. Touchpad 30 is attached to pickguard 122 of guitar 140 using screws, adhesive, clips, friction coupling, or other suitable attachment mechanism. Alternatively, touchpad 30 can be attached directly to body 102.

Motion-sensitive control surfaces 30, 108a, 108b, 112a, and 116a are connected to UICS 32. Control surfaces 30, 108a, 108b, 112a, and 116a allow a guitarist to input commands into UICS 32. The guitarist inputs commands into UICS 32 by performing a gesture on or over control surfaces 30, 108a, 108b, 112a, and 116a. UICS 32 sends control signals to internal circuitry of guitar 140 or external devices coupled to guitar 140 in response to gestures performed on or over control surfaces 30, 108a, 108b, 112a, and 116a.

UICS 32 is programmed to recognize a gesture performed over one control surface of guitar 140 from the same gesture performed over a different control surface of guitar 140. UICS 32 assigns a unique control signal to each gesture or combination of gestures performed over one or more of control surfaces 30, 108a, 108b, 112a, and 116a. For example, the control signal sent in response to a double tap on control surface 108b is different from the control signal sent in response to a double tap on surface 34 of touchpad 30. The control signal sent in response to a three-finger slide on control surface 108b is different from the control signal sent in response to a one-finger slide on control surface 108b.

When a gesture is performed on or over control surfaces 30, 108a, 108b, 112a, or 116a, UICS 32 outputs the control signal assigned to the gesture and control surface. The control signal is routed to internal circuitry of guitar 140 and/or to accessories coupled to guitar 140. Assigning a unique control signal to each gesture and each control surface increases the functionality of UICS 32. The number of recognizable gestures and the number of control surfaces are directly related to the number of control signals that can be programmed into UICS 32. Increasing the number of recognized gestures and/or the number of control surfaces increases the number of devices and functions that can be controlled from guitar 140.

FIG. 4c shows a guitar 150, similar to guitar 100 in FIG. 4a. Surfaces 108 and 112, headstock 116, and pickguard 122 on guitar 150 are each control surfaces. The entire surface 108 of body 102 is motion-sensitive. The entire surface 112 of body 102 is motion-sensitive. The entire surface of pickguard 122 is motion-sensitive. Both surfaces of headstock 116, i.e., the surface corresponding to strings 106 and the surface opposite strings 106, are entirely motion-sensitive. The control surfaces are capable of detecting a presence and location of multiple points of contact or motion. Motion-sensitive headstock 116, pickguard 122, and surface 108 and 112 detect the xyz coordinates of points of contact. The control surfaces employ capacitive, resistive, optical, laser, wave, force sensing, electromagnetic, or other suitable motion detection technology to detect and distinguish points of contact or motion on or above the control surface. The plural-point and z-axis awareness of control surfaces 108 and 112, headstock 116, and pickguard 122 allow guitar 150 to detect and distinguish between a plurality of gestures.

Control surfaces 108 and 112, headstock 116, and pickguard 122 are connected to UICS 32. Control surfaces 108 and 112, headstock 116, and pickguard 122 are used to input commands into UICS 32. A guitarist inputs commands into UICS 32 by performing gestures on or over control surfaces 108 and 112, headstock 116, and pickguard 122. UICS 32 sends control signals to internal circuitry of guitar 150 or external devices coupled to guitar 150 in response to gestures performed on or over control surfaces 108 and 112, headstock 116, and pickguard 122. UICS 32 is configured to distinguish and recognize gestures performed on or over the different control surfaces of guitar 150. UICS 32 assigns a unique control signal to each gesture or combination of gestures performed over each control surface. For example, the control signal sent in response to a double tap on control surface 108 is different from the control signal sent in response to a double tap on control surface 112. The control signal sent in response to a three-finger slide on control surface 122 is different from the control signal sent in response to a one-finger slide on control surface 122. Assigning a unique control signal to each gesture and each control surface increases the functionality of UICS 32. The number of recognizable gestures and the number of distinguishable control surfaces are directly related to the number of control signals that can be programmed into UICS 32. Increasing the number of recognized gestures and/or the number of control surfaces increases the number of devices and functions that can be controlled from guitar 150.

FIG. 4d shows a guitar 160 similar to guitar 140 in FIG. 4b. Guitar 160 includes control surface selector switch or knob 162 to change the operation and sensitivity of motion-sensitive control surfaces 30, 108a, 108b, 112a, and 116a. That is, control surface selector knob 162 sets UICS 32 to recognize gestures from control surfaces 30, 108a, 108b, 112a, and 116a as assigned to selectable control functions. By making adjustments through control surface selector knob 162, UICS 32 can be set to recognize specific gestures from control surface 30 as assigned to amplification, filtering, tone equalization, sound effects, bass, treble, midrange, reverb dwell, reverb mix, vibrato speed, and vibrato intensity control functions. For example, in one setting of control surface selector knob 162, UICS 32 recognizes a first gesture on control surface 30 as controlling amplification, a second gesture as controlling filtering, a third gesture as controlling tone equalization, a fourth gesture as controlling sound effects, and so on. In another setting of control surface selector knob 162, UICS 32 recognizes the same first gesture on control surface 30 as controlling the synthesizer, the same second gesture as controlling the foot pedal, the same third gesture as controlling lighting, and the same fourth gesture as controlling another musical instrument. Alternatively, control surface selector knob 162 can enable and disable the operation of various control surfaces 30, 108a, 108b, 112a, and 116a. Control surface selector knob 162 can set the control surface to recognize different regions of control surface operation, as described in FIG. 3g.

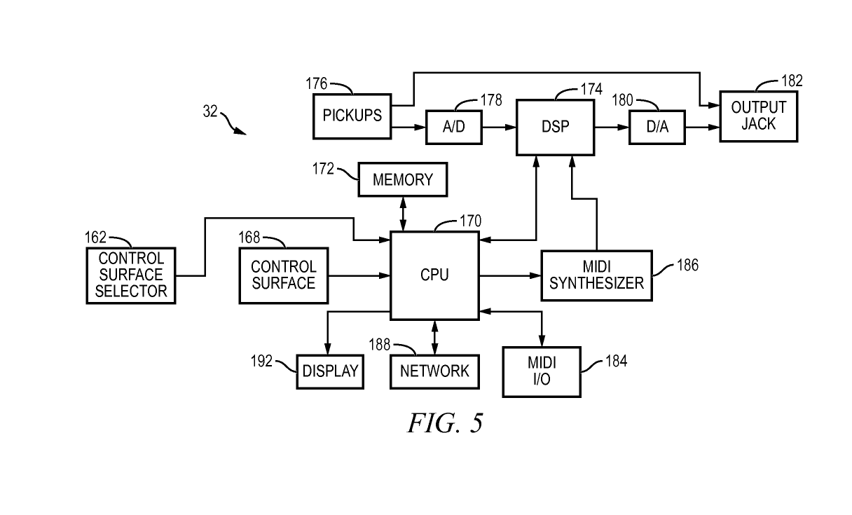

FIG. 5 illustrates a functional block diagram of UICS 32. UICS 32 receives sets of xyz coordinates derived from the user interaction with motion-sensitive control surface 168, e.g., surface 34 of touchpad 30 or control surfaces 108a, 108b, 112a, 116a, and 122a. Control surface 168 detects the position, magnitude, and movement of the points of contact or motion and generates electrical signals corresponding to the position, magnitude, and movement in xyz coordinates on or above control surface 168. UICS 32 recognizes gestures from the sets of xyz coordinates and executes control functions based on control surface selector knob 162, see discussion of FIG. 4d. The gesture can be any body movement (hand, finger, arm, leg, foot, head, etc.) intended for virtual control of guitar 10. UICS 32 assigns a unique control signal to each gesture or combination of gestures detected by control surface 168. UICS 32 can also recognize a unique sequence or combination of gestures and generate a control signal assigned to the unique combination of gestures. UICS 32 and control surface 168 are configured such that the function of the control signal, e.g., selecting pickups, adding reverb, or controlling special effects, happens in coordination with the gesture being performed on the control surface. UICS 32 lets a guitarist modify properties of the audio signal by sending control signals to signal processing equipment onboard guitar 10 or by sending control signals to accessories coupled to guitar 10. During a live performance, the guitarist can adjust the settings of amplifiers, effects boxes, speakers, mixers, stage lighting, special effects machines, or other devices using guitar 10 and touchpad 30. The control signals from UICS 32 modify and control properties of the audio signal generated by guitar 10 after the audio signal has been output from audio output jack 28. For example, a guitarist can use touchpad 30 and UICS 32 to send a control signal to an amplifier connected to guitar 10 via output jack 28, causing the amplifier to change volume or accentuate bass frequencies. UICS 32 also sends control signals to non-musical accessories. For example, a guitarist can send control signals to stage lighting, fog machines, lasers, props, audio video, mobile device, or other special effects devices using touchpad 30 and UICS 32.

UICS 32 includes one or more processors, volatile memories, non-volatile memories, control logic and processing, interconnect busses, firmware, and software to interpret the contact or motion detected on touchpad 30 and implement the requisite control function. Volatile memory includes latches, registers, cache memories, static random access memory (SRAM), and dynamic random access memory (DRAM). Non-volatile memory includes read-only memory (ROM), programmable read-only memory (PROM), erasable programmable read-only memory (EPROM), electrically erasable programmable read-only memory (EEPROM), serial EPROM, magneto-resistive random-access memory (MRAM), ferro-electric RAM (F-RAM), phase-change RAM (PRAM), and flash memory. Control logic and processing includes programmable digital input and output ports, digital to analog converters (DAC), analog to digital converters (ADC), display controllers, keyboard controllers, universal serial bus (USB) controllers, universal synchronous/asynchronous receiver/transmitter (USARTs), (current-current) I2C controllers, network interface controllers (NICs), and other network communication circuits. UICS 32 uses signal processors, accelerators, or other specialized circuits for functions such as motion extrapolation and interpretation. UICS 32 is also capable of performing functions such as audio synthesis, signal conditioning, signal distribution, signal compression, filtering, noise reduction, encryption, and electronic data storage.

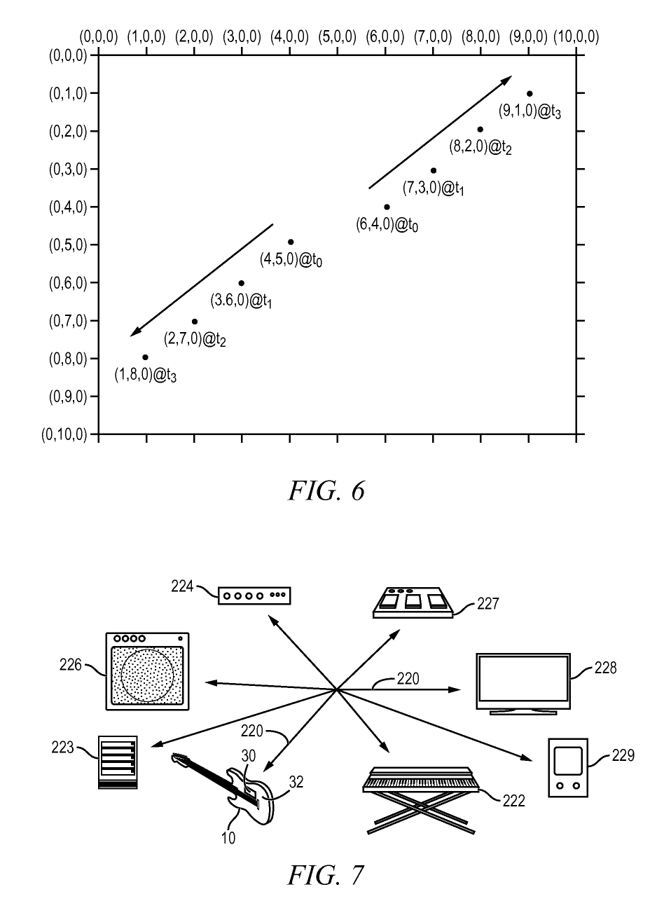

In one embodiment of UICS 32, the electrical signals are sent from motion-sensitive control surface 168 to a central processing unit or controller 170. Controller 170 interprets the data, i.e., electrical signals, received from control surface 168 based on control surface selector knob 162 to recognize the gesture or other movement and then generate control signals based on the gesture. For example, control surface 168 provides a series of xyz coordinates of the movement of hand 42 or fingers 44-46 over time. FIG. 6 shows a diagram of xyz coordinates of fingers 44-46 over times t0-t3. At initial time t0, finger 44 is at (4,5,0) and finger 46 is at (6,4,0). At time t1, finger 44 is at (3,6,0) and finger 46 is at (7,3,0). At time t2, finger 44 is at (2,7,0) and finger 46 is at (8,2,0). At time t3, finger 44 is at (1,8,0) and finger 46 is at (9,1,0). Controller 170 analyzes the total movement of the hand or fingers as defined by the changing xyz coordinates over time and recognizes a pattern or gesture associated with the total movement. The changing xyz coordinates over time in FIG. 6 shows a continuously expanding linear progression of xyz coordinates which maps to the pinch-open gesture of FIGS. 3a-3b. Controller 170 associates the pinch-open gesture with a specific function and outputs the control signals to other components of UICS 32 in accordance with the recognized function, e.g., pinch-open gesture increases volume to the audio amplifier. Other examples of gestures include one-finger tap, one-finger double tap, one-finger slide, one-finger slide and tap combination, one-finger slide and double tap combination, one-finger flick, multi-finger tap, multi-finger double tap, multi-finger slide, multi-finger slide and tap combination, multi-finger slide and double tap combination, multi-finger flick, drag, rotation, circle, oval, arc, triangle, square, hover, moving-hover, or other detectable gesture made by user interaction. Controller 170 can recognize many different combinations of fingers, directions, patterns, and gestures over different portions of control surface 168 corresponding to the intended control function, see examples of FIGS. 3a-3g.

Returning to FIG. 5, controller 170 is coupled to a memory 172. Controller 170 accesses memory 172 to store software, settings, musical instrument digital interface (MIDI) files, sampled audio, or other information controller 170 needs to access during the operation of UICS 32. Memory 172 can be implemented as one or more storage devices such as, random access memory (RAM), ROM, EPROM, removable memory devices, and magnetic storage, e.g., hard disk. Memory 172 can store computer-readable program code instructions used to operate controller 170.

Controller 170 manages and controls the flow of audio signals, control signals, and other electrical signals within UICS 32. Controller 170 also manages and controls the flow of audio signals, control signals, and other electrical signals between UICS 32 and external devices coupled to UICS 32. Controller 170 routes control signals, audio signals, and other electrical signals to digital signal processor (DSP) 174. DSP 174 performs a variety of signal processing activities in response to control signals received from controller 170. DSP 174 performs signal processing on audio signals input into UICS 32 via pickups 176.

Pickups 176, e.g., pickups 26 on guitar 10 or pickups 126 on guitar 100, generate analog signals representative of sound. In one embodiment, the analog signals generated by pickups 176 are sent directly to output jack 182, e.g., output jack 28 on guitar 10 or output jack 128 on guitar 100. Alternatively, the analog signals generated by pickups 176 are routed to ADC 178. ADC 178 converts the analog signals generated by pickups 176 to digital signals. The digitized signals are sent from ADC 178 to DSP 174. DSP 174 performs signal processing and conditioning on audio signals received from ADC 178 and other inputs according to commands received from controller 170. The modified signal is sent from DSP 174 to DAC 180. DAC 180 converts the digital signals sent from DSP 174 to analog audio signals. The audio signals are routed from DAC 180 to audio output jack 182.

DSP 174 identifies a number of devices that perform signal processing and conditioning on audio signals within UICS 32. The devices can include effects processors, signal conditioners, signal distributors, signal converters, amplifiers, bandpass filters, or other devices that employ algorithms and/or circuits to perform signal processing and conditioning. DSP 174 is configured to receive, process, and combine audio signals from multiple inputs. DSP 174 performs amplification, equalization, balance, delay, echo, reverberation, chorus, tremolo, vibrato, panning, or other sound effects on the audio signals. DSP 174 modifies audio signals to simulate a sound associated with a particular type of cabinet, amp, preamp, pickup, or guitar.

DSP 174 provides various filtering functions, such as low-pass filtering, bandpass filtering, and tone equalization functions over various frequency ranges to boost or attenuate the levels of specific frequencies without affecting neighboring frequencies, such as bass frequency adjustment and treble frequency adjustment. For example, the tone equalization employs shelving equalization to boost or attenuate all frequencies above or below a target or fundamental frequency, bell equalization to boost or attenuate a narrow range of frequencies around a target or fundamental frequency, graphic equalization, or parametric equalization. DSP 174 introduces sound effects into an audio signal, such as reverb, delays, chorus, wah-wah, auto-volume, phase shifter, hum canceller, noise gate, vibrato, pitch shifting, tremolo, and dynamic compression. DSP 174 performs customized signal processing functions defined by the user, such as adding accompanying instruments, vocals, and synthesizer options. DSP 174 can perform any number of signal processing functions depending upon the nature of the analog or digital audio signal and the control signals received from controller 170. Upon receiving a gesture on control surface 168, controller 170 controls one or more of the above functions associated with DSP 174 based on the control function assigned to the gesture.

UICS 32 is configured to send, receive, and store digital audio files. The digital audio files can be in the form of MIDI files or files in related encoded formats, such as MP3 or MP4. UICS 32 sends and receives control signals via a MIDI input output jack (MIDI I/O) 184 provided on the guitar.

UICS 32 is configured to receive MIDI signals from computers, keyboards, synthesizers, cell phones, sound effects machines, or other devices capable of transmitting a MIDI signal stream. MIDI signals are input into UICS 32 from an external source, e.g., a PC, tablet, synthesizer, or keyboard, via MIDI I/O 184. MIDI signals are used with electronic devices to generate musical instruments such as drums, guitars, horns, keyboards, tambourines, organs, wind instruments, and string instruments. MIDI signals can also be used to synthesize vocals and natural sounds. Controller 170 routes the MIDI signals from MIDI I/O 184 to memory 172 for storage, to DSP 174 for signal processing, or to MIDI synthesizer 186 for generation of a synthesized audio signal. Controller 170 also routes MIDI signals generated by DSP 174 and preprogrammed MIDI files stored within memory 172.

MIDI synthesizer 186 generates audio signals or synthesizes sounds based on MIDI signals received from controller 170. MIDI synthesizer 186 can synthesize any tune, melody, song, individual instrument, combination of instruments, or sound effect. The MIDI signal corresponding to each synthesizable sound is assigned to a gesture. Upon receiving a gesture on control surface 168, controller 170 sends the MIDI signal assigned to the gesture to MIDI synthesizer 186. MIDI synthesizer 186 synthesizes the audio signal corresponding to the assigned sound. The synthesized audio signal is sent from MIDI synthesizer 186 to DSP 174. DSP 174 combines the synthesized audio from MIDI synthesizer 186 with the digitized audio signals received from ADC 178 and outputs a composite signal through DAC 180 to output jack 182. The composite audio signal is routed from output jack 182 to a receiving device, for example, an amplifier, speaker, or other musical instrument, coupled to output jack 182. The composite signal can also be routed from DSP 174 to controller 170. Controller 170 sends the composite signal to memory 172 for storage or outputs the signal from UICS 32 via MIDI I/O 184 or network 188.

UICS 32, controller 170, DSP 174, and MIDI synthesizer 186 let a guitarist mix and modify a variety of sounds. The guitarist is able to create new and unique sounds using control system 32 and control surface 168. For example, a guitarist using guitar 100 from FIG. 4a wants to add a particular drumbeat to the guitar sounds. UICS 32 of guitar 100 is programmed, in combination with control surface selector knob 162, PC, or tablet, to recognize a double tap on control surface 116a as a command to generate the drumbeat. The guitarist begins to strum strings 106 of guitar 100 and pickups 126 generate an audio signal corresponding to vibrating strings 106. While playing guitar 100, the guitarist performs a double tap on control surface 116a. Control surface 116a detects the double tap and sends electrical signals corresponding to a double tap gesture on surface 116a to controller 170. Controller 170 interprets the electrical signals from control surface 116a and generates the MIDI signal assigned to a double tap on surface 116a (drumbeat). The MIDI signal is sent from controller 170 to MIDI synthesizer 186. MIDI synthesizer 186 generates an audio signal corresponding to the desired drumbeat and sends the audio signal to DSP 174. DSP 174 combines the drumbeat signal with the audio signal corresponding to vibrating strings 106. The composite signal is output through audio output jack 128 to a speaker coupled to guitar 100. The speaker reproduces the composite signal and the guitarist hears the sounds from guitar 100, i.e., vibrating strings 106, mixed with the synthesized drumbeat.

UICS 32 also uses MIDI signals to communicate with and control other musical instruments and external devices. The MIDI signals are used to control sound generation and other features of the external device. The MIDI signals can specify pitch, velocity, volume, vibrato, audio panning, cues, and clock signals. MIDI signals can be sent to configure and synchronize the tempo of multiple instruments and devices.

Controller 170 generates control signals in the form of MIDI signals in response to gestures performed on control surface 168. Controller 170 routes the MIDI signals to the external devices via MIDI I/O 184. A guitarist can control any instrument or device configured to receive MIDI signals using control surface 168, in combination with control surface selector knob 162.

For example, a guitarist using guitar 10 wants to control when a keyboard starts playing a prerecorded melody contained on the keyboard. UICS 32 of guitar 10 is programmed to send a MIDI signal instructing the keyboard to generate the prerecorded melody upon receiving a one-finger circular gesture in a clockwise direction on surface 34 of touchpad 30. When the guitarist wants the keyboard to start playing the prerecorded melody, the guitarist performs the one-finger circular gesture in a clockwise direction on surface 34 of touchpad 30, i.e., the guitarist contacts surface 34 of the touchpad with one finger and rotates the finger along surface 34 in a clockwise direction. Touchpad 30 detects the initial points of contact made by the finger and senses the clockwise movement of points of contact. Touchpad 30 generates electrical signals representative of the initial xyz coordinates of the points of contact of touchpad 30. As the location of the points of contact changes, i.e., as the finger rotation along surface 34, touchpad 30 generates electrical signals representative of the xyz coordinates corresponding to the gesture. Controller 170 interprets the electrical signals from touchpad 30 and generates a control signal assigned to the clockwise finger rotation on touchpad 30 (keyboard plays melody). The control signal is sent from controller 170 to the keyboard, which plays the desired melody.

UICS 32 also communicates with and controls other instruments and external devices connected to a communication network 188. UICS 32 sends MIDI signals, control signals, and other electrical signals to musical instruments and external devices connected to network 188. UICS 32 also receives MIDI signals, control signals, and other electrical signals from musical instruments and external devices connected to network 188. The musical instruments and accessories connected to network 188 each include an internal or external wired or wireless transceiver or communication link for sending and receiving analog or digital audio signals, control signals, and other data from devices connected to network 188. The wired or wireless transceiver can be disposed internally or on the body of the musical instrument.

A guitarist can control any device connected to network 188 using control surface 168. UICS 32 assigns control signals for external device to gestures recognized by control surface 168, in combination with control surface selector knob 162. Controller 170 generates control signals in response to the gestures being performed on or over control surface 168. Controller 170 routes the assigned control signals to the external devices via network 188.

For example, a guitarist using guitar 140 from FIG. 4b wants to control the tempo of a melody produced by a keyboard. The keyboard and guitar 140 are both connected to network 188. UICS 32 of guitar 140 is programmed to send a control signal instructing the keyboard to increase or decrease the tempo of the melody in response to a one-finger slide gesture over control surface 112a. UICS 32 is programmed to send an increase tempo signal in response to a one-finger slide on surface 112a moving toward neck 104 and to send a decrease tempo signal in response to a one-finger slide on surface 112a moving away from neck 104.

When the guitarist wants the keyboard to increase the tempo of the melody, the guitarist performs a one-finger slide along surface 112a toward neck 104, i.e., the guitarist uses one-finger to contact surface 112a in an area of surface 112a distal to neck 104 and slides the finger along surface 112a toward neck 104. Control surface 112a detects the initial point of contact made by the finger and senses the movement of the point of contact toward neck 104. Control surface 112a generates electrical signals representative of the initial xyz coordinates of the points of contact on surface 112a. As the location of the point of contact changes, i.e., as the finger slides toward neck 104, control surface 112a generates electrical signals representative of the next xyz coordinates on surface 112a corresponding to the gesture. The electrical signals generated by control surface 112a are sent to controller 170. Controller 170 interprets the electrical signals received from control surface 112a, recognizes that the electrical signals indicate a one-finger slide on surface 112a toward neck 104 and generates the control signal assigned to a one-finger slide on surface 112a toward neck 104, i.e., the control signal instructing the keyboard to increase the tempo of the melody. The control signal is routed from controller 170 to the keyboard via network 188. Upon receiving the control signal from UICS 32, the keyboard increases tempo of the melody during the duration of the one-finger slide on surface 112a. The guitarist stops sliding the finger toward neck 104 when the guitarist is satisfied with the tempo of the melody.

When the guitarist wants the keyboard to decrease the tempo of the melody, the guitarist slides one-finger along surface 112a in a direction away from neck 104. As the location of the point of contact changes, i.e., as the finger slides away from neck 104, control surface 112a generates electrical signals representative of the next xyz coordinates on surface 112a corresponding to the gesture. The electrical signals generated by control surface 112a are sent to controller 170. Controller 170 interprets the electrical signals received from control surface 112a, recognizes that the electrical signals indicate a one-finger slide on surface 112a away from neck 104, and generates the control signal assigned to a one-finger slide on surface 112a away from neck 104, i.e., the control signal instructing the keyboard to decrease the tempo of the melody. The control signal is routed from controller 170 to the keyboard via network 188. Upon receiving the control signal from UICS 32, the keyboard decreases tempo of the melody during the duration of the one-finger slide on surface 112a.

The guitarist can continuously slide one-finger along surface 112a toward and away from neck 104 to repeatedly increase and decrease the tempo of the melody produced by the keyboard. UICS 32 allows the guitarist to control the keyboard or any other instrument connected to network 188 from guitar 140.

UICS 32 is programmable. An external control device, such as a personal computer or tablet, can control the operation of UICS 32 and control surface 168 via wired or wireless connection, such as network 188. The external control device can assign the control function or combination of control functions to each gesture or combination of gestures. The control function assigned to a gesture on a control surface can be changed at any time via the external control device. The external control device can change the operation or sensitivity of control surface 168 using control surface selector knob 162, as described in FIG. 4d, as well as changing parameters of UICS 32 depending on the application. For example, a guitarist is performing a set of songs that require the guitarist to employ an effects box. The guitarist programs UICS 32 to send a particular control signal, e.g., an add wah-wah signal, to the effects box upon recognition of a pinch-open gesture. When the guitarist wants to add a wah-wah effect, the guitarist performs the pinch-open gesture on control surface 168. In response to the pinch-open gesture, controller 170 sends an add wah-wah control signal to the effects box via MIDI I/O 184 or network 188 and the effects box adds wah-wah to the audio signal. Later the guitarist is doing a different set of songs that do not employ the effects box. The guitarist reprograms UICS 32 via the external control device or control surface selector knob 162 to assign a different control signal to the pinch-open gesture, e.g., a control signal instructing MIDI synthesizer 186 to generate a prerecorded melody. When the guitarist wants to add the melody, the guitarist performs a pinch-open gesture on the control surface 168. In response to the pinch-open gesture, controller 170 sends the control signal corresponding to the melody to the MIDI synthesizer 186, and MIDI synthesizer 186 generates an audio signal corresponding to the melody. The audio signal is routed from MIDI synthesizer 186 to DSP 174, and then output from UICS 32.

UICS 32 is programmed to assign the control function to each gesture or combination of gestures by software operating on an external device, for example, a PC or tablet, or with internal software of UICS 32 using control surface 168, display 192, and control surface selector knob 162. UICS 32 is programmed to control onboard signal processing equipment, i.e., devices that perform signal processing on the audio signal prior to the audio signal being output from output jack 182. UICS 32 is also programmed to control outboard signal processing devices, i.e., devices that perform signal processing on the audio signal after the signal has been output from output jack 182.

UICS 32, controller 170, and control surface 168 are programmed and configured to control the signal processing and functionality of multiple devices simultaneously. For example, UICS 32 of guitar 10 in FIG. 3f is programmed such that, a three-finger slide toward strings 16 in region 64b of touchpad 30 causes controller 170 to simultaneously send an increase amplification control signal to DSP 174, an adjust equalization control signal to an amplifier coupled to MIDI I/O 184, and a turn on fog control signal to a fog machine connected to network 188.

UICS 32 controls outboard signal processing equipment and other devices by sending control signals to the devices via MIDI I/O 184 or network 188. The devices receive the control signals from UICS 32 via a wired or wireless connection. UICS 32 sends control signals to amplifiers, speakers, effects machines, mixing workstations, microphones, mobile devices, or other instruments coupled MIDI I/O 184 or network 188. UICS 32 also sends control signals to stage lights, fog machines, laser, pyrotechnic devices, audio video, or other special effects devices connected to network 188. UICS 32 lets a guitarist control any device connected to MIDI I/O 184 or network 188 from control surface 168.

In one embodiment, an LED or LCD display 192 is incorporated into UICS 32. The software executing within UICS 32 controls display 192. UICS 32 and display 192 can also be controlled via PC or tablet or control surface selector knob 162 to display different menu and submenu levels in a hierarchical manner. Display 192 can be programmed to display menus of signal processing functions, information formats, devices coupled to UICS 32, and other operating information. Display 192 changes with the user selections to provide different configurations of operational menus. The configuration of display 192 depends on a device selected and desired signal processing functions available. For example, a menu for controlling signal processing features of an amplifier connected to UICS 32 is different from a menu for controlling stage lighting. Labels for the various signal processing functions, devices, and customized controls are incorporated into a graphical user interface (GUI) of display 192. The user touches a particular area of control surface 168 consistent with an image on display 192 to select the function, receiving device, or menu corresponding to the image on display 192. Display 192, in conjunction with control surface 168, provides control over operational modes, access to menus for selecting and editing functions, and control of an overall configuration of UICS 32. Display 192 shows control functions such as, volume, tone, frequency response, equalization, and other sound control functions for the musical instrument incorporating UICS 32 and devices coupled to the musical instrument.

FIG. 7 illustrates guitar 10 communicating with and controlling musical instruments and accessories connected within communication network 188. Guitar 10 uses wired or wireless direct communication links 220 to send and receive analog or digital audio signals, control signals, and other data from devices connected to communication network 188. In the present embodiment, guitar 10 communicates with musical instruments 222 (depicted as an electric keyboard), amplifier 224, speaker 226, effects box 227, display 228, and mobile device 229, via communication links 220. Other electronic accessories, such as synthesizers, theremins, samplers, computers, tablets, cell phones, or other devices can be connected to guitar 10 via communication network 188. Other musical instruments, e.g., a bass guitar, violin, horn, drum, wind instrument, string instrument, piano, or organ, can be connected to guitar 10 via network 188. For musical instruments that emit sound waves directly, a microphone or other sound transducer is attached to or disposed near the musical instrument. The microphone converts the sound waves from the musical instrument to electrical signals or MIDI data, which can be transmitted over communication links 220.

Guitar 10 uses wired or wireless communication links 220 to send and receive data signals to and from external server 223. Any musical performance or configuration can be stored on server 223 and retrieved for later use.

Guitar 10, musical instrument 222, and accessories 223-229 each include an internal or external wireless transceiver or communication link and controller to send and receive analog or digital audio signals, control signals, and other data from guitar 10. Guitar 10 polls, identifies, and connects to musical instrument 222 through communication links 220; guitar 10 polls, identifies, and connects to audio amplifier 224, speaker 226, effects box 227, display 228, and mobile device 229 through communication links 220. Guitar 10 can communicate, configure, and send control signals to devices 222-229 or any other device within communication network 188. UICS 32 of guitar 10 sends control signals to devices 222-229 through network 188 and communications links 220. UICS 32 sends the control signals in response to gestures performed on or over touchpad 30.

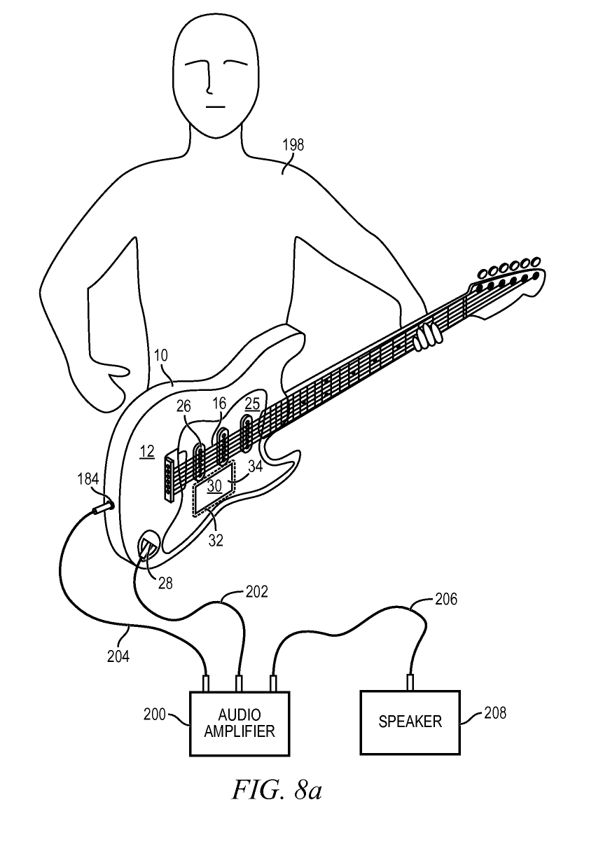

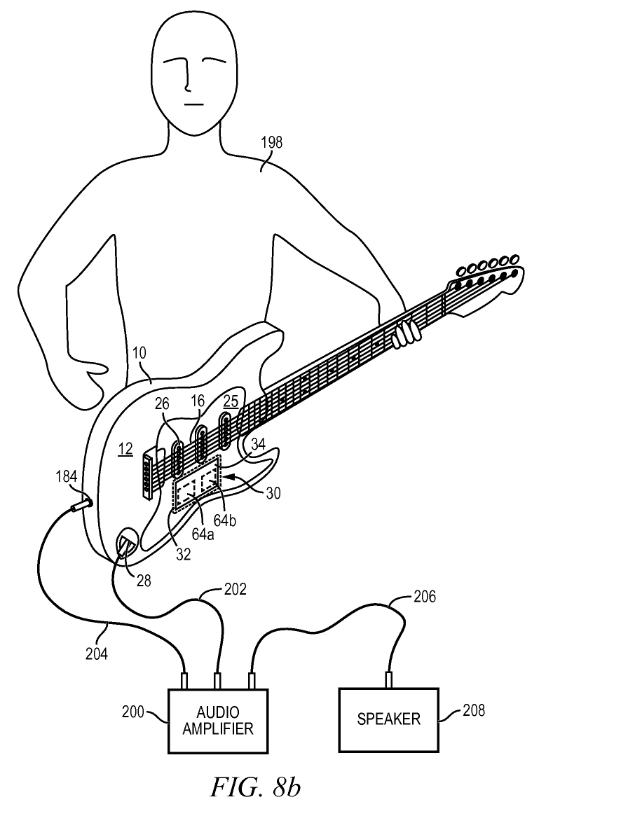

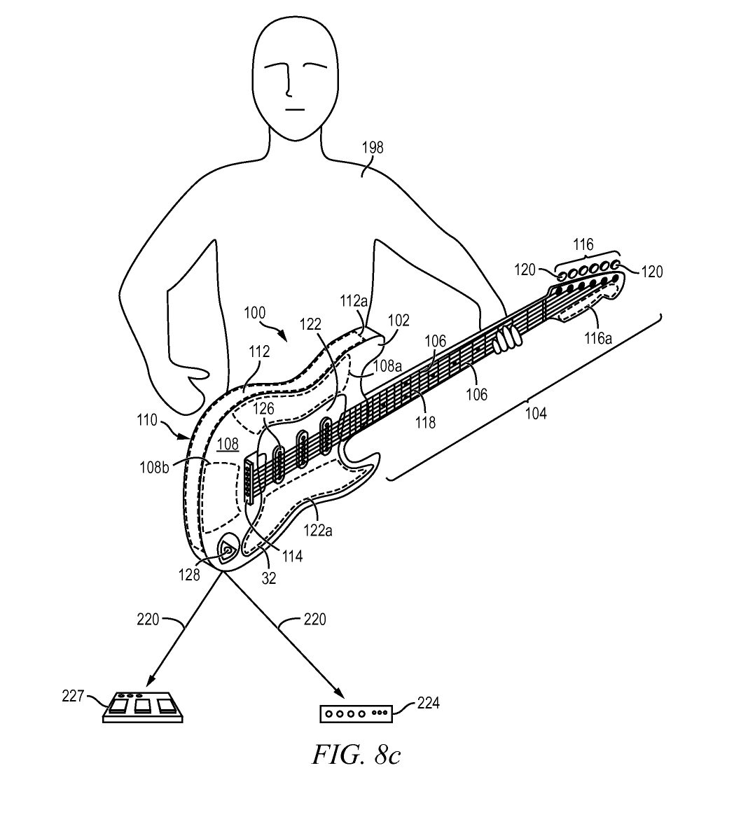

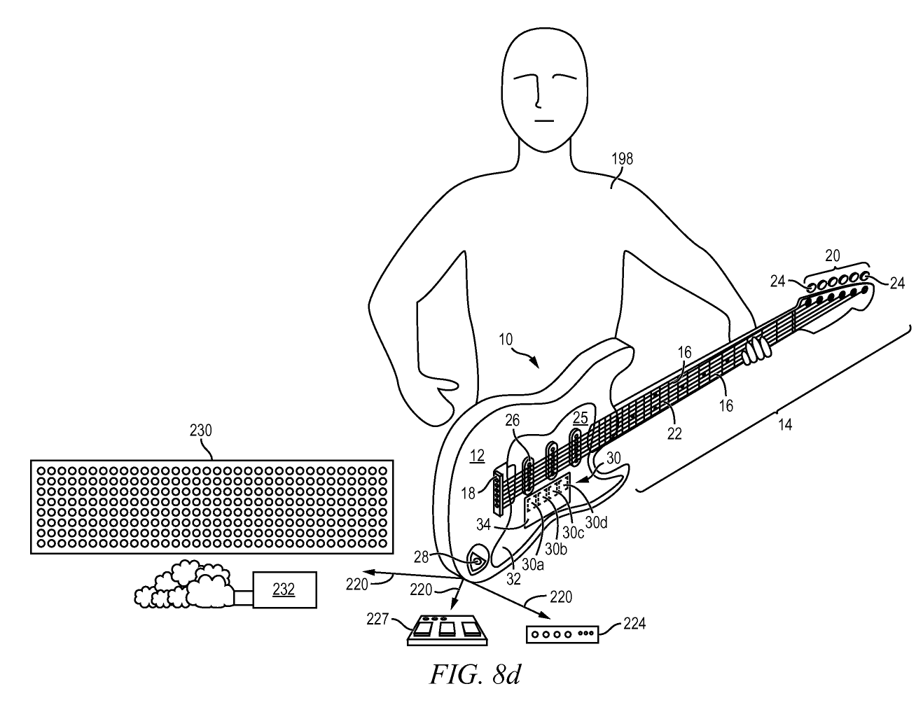

FIG. 8a shows a guitarist 198 playing guitar 10 from FIG. 1. Guitar 10 is coupled to an audio amplifier 200. Audio signals from guitar 10 are routed from audio output jack 28 through audio cable 202 to audio amplifier 200. Amplifier 200 is configured to receive MIDI signals. MIDI signals, i.e., control signals, are generated by controller 170 in response to a gesture performed on touchpad 30. The MIDI signals are output from guitar 10 via MIDI I/O 184. The MIDI signals are routed from MIDI I/O 184 through audio cable 204 to a MIDI input jack on audio amplifier 200. Control software and circuitry within audio amplifier 200 interprets the MIDI signal received from controller 170. Amplifier 200 performs a particular signal processing function on the audio signal from audio cable 202 based upon the MIDI signal received from audio cable 204.

The signal processing provided by audio amplifier 200 includes amplification, filtering, equalization, sound effects, user-defined modules, and other signal processing functions that adjust the power level and enhance the signal properties of the audio signal output from audio output jack 28. The processed audio signal is routed from audio amplifier 200 through audio cable 206 to speaker 208. Speaker 208 audibly reproduces the audio signal originating from guitar 10 with the enhancements introduced by audio amplifier 200 for recognition and appreciation by an audience or listener.

The MIDI signal sent by controller 170 determines what type of signal processing function will be performed by amplifier 200. Controller 170 determines what MIDI signal to send based upon the electrical signals, i.e., point of contact data, received from touchpad 30. The electrical signals sent from touchpad 30 are representative of a gesture performed on or over surface 34.

UICS 32 controls guitar 10 and accessories coupled to guitar 10 using gesture specific control signals. UICS 32 assigns a unique control signal to each gesture or combination of gestures detected by touchpad 30. Each time a recognized gesture is performed on or over touchpad 30, the control signal assigned to the gesture is generated by controller 170 and sent to the assigned device, e.g., DSP 174 or amplifier 200.

For example, UICS 32 of guitar 10 is configured to send an increase amplification control signal to amplifier 200 in response to a pinch-open gesture performed over touchpad 30, and a decrease amplification control signal in response to a pinch-close gesture. Guitarist 198 wants to increase amplification of the audio signal output from amplifier 200. Guitarist 198 performs a pinch-open gesture on surface 34 of touchpad 30, i.e., guitarist 198 contacts surface 34 with two fingers that are initially close together and then guitarist 198 slides the fingers apart. Touchpad 30 detects the two initial points of contact and senses the movement of the points of contact. Touchpad 30 generates electrical signals representative of the initial xyz coordinates of surface 34. As the location of the points of contact changes, i.e., as the fingers move apart, electrical signals representative of the next xyz coordinates corresponding to the gesture are generated. The electrical signals generated by touchpad 30 are sent to controller 170. Controller 170 interprets the electrical signals received from touchpad 30 and recognizes that the electrical signals indicate a pinch-open gesture. Controller 170 then generates the control signal assigned to a pinch-open gesture, i.e., a MIDI signal instructing amplifier 200 to increase amplification. The control signal is routed from controller 170 to amplifier 200 via MIDI I/O 184 and audio cable 204. Upon receiving the control signal from UICS 32, amplifier 200 increases an amplification of the audio signal received from audio cable 202. The amplified audio signal is output to speaker 208 via audio cable 206.

Touchpad 30 continues to generate electrical signals representative of the points of contact moving apart and controller 170 continues to send increase amplification control signals. In other words, the pinch-open gesture is a continuous series of progressively wider pinch-open gestures. Amplifier 200 continues to increase the amplification of the audio signal during the duration of the pinch-open gesture. Guitarist 198 stops performing the pinch-open gesture, i.e., stops spreading the two fingers apart, when guitarist 198 is satisfied with the amplification of the audio signal.

When guitarist 198 wants to decrease the amplification of the audio signal, guitarist 198 performs a pinch-close gesture over surface 34. As the location of the points of contact changes, i.e., as the fingers come together, touchpad 30 generates electrical signals representative of the changing xyz coordinates on surface 34 corresponding to the gesture. The electrical signals generated by touchpad 30 are sent to controller 170. Controller 170 interprets the electrical signals received from touchpad 30, recognizes that the electrical signals indicate a pinch-close gesture, and generates the control signal assigned to a pinch-close gesture, i.e., a MIDI signal instructing amplifier 200 to decrease amplification. The control signal is routed from controller 170 to amplifier 200 via MIDI I/O 184 and audio cable 204. Upon receiving the new control signal from UICS 32, amplifier 200 decreases the amplification of the audio signal received from audio cable 202.

Touchpad 30 continues to generate electrical signals representative of the points of contact moving together, controller 170 continues to send decrease amplification control signals, and amplifier 200 continues to decrease the amplification of the audio signal during the duration of the pinch-close gesture. Guitarist 198 stops performing the pinch-close gesture, when guitarist 198 is satisfied with the amplification of the audio signal. Guitarist 198 can repeatedly increase and decrease the amplification of the audio signal by continuously sliding two fingers apart and together over surface 34.

UICS 32 also controls a guitar and accessories coupled to the guitar by assigning unique control signals to different areas of a control surface, e.g., selected through control surface selector knob 162. For example, UICS 32 of guitar 10 in FIG. 8b is configured to send control signals that cause amplifier 200 to modify treble frequencies in response to gestures performed in region 64a of surface 34 and control signals that cause amplifier 200 to modify bass frequencies in response to gestures performed in region 64b of surface 34.

UICS 32 is programmed to send an emphasize treble frequencies control signal in response to a one-finger slide moving away from strings 16 in region 64a. UICS 32 is programmed to send a deemphasize treble frequencies control signal in response to a one-finger slide moving toward strings 16 in region 64a. UICS 32 is programmed to send an emphasize bass frequencies control signal in response to one-finger slide moving away from strings 16 in region 64b. UICS 32 is programmed to send a deemphasize bass frequencies control signal in response to a one-finger slide moving toward strings 16 in region 64b.

Guitarist 198 wants amplifier 200 to emphasize treble frequencies. Guitarist 198 contacts surface 34 with one-finger or a guitar pick in region 64a and then slides the finger away from strings 16. Touchpad 30 detects an initial point of contact in control region 64a and senses the point of contact is moving away strings 16. Touchpad 30 generates an electrical signal representative of the initial xyz coordinates of region 64a. As the location of the point of contact changes, i.e., as the finger moves away from strings 16, touchpad 30 generates electrical signals representative of the next xyz coordinates corresponding to the gesture. The electrical signals generated by touchpad 30 are sent to controller 170. Controller 170 interprets the electrical signals received from touchpad 30 and recognizes that the electrical signals indicate a point of contact sliding away from strings 16 in region 64a. Controller 170 then generates the control signal assigned to a point of contact sliding away from strings 16 in region 64a, i.e., a control signal instructing amplifier 200 to emphasize treble frequencies. Controller 170 sends the increase treble frequency control signal because the electrical signals received from touchpad 30 are representative of contact made in control region 64a. The control signal is routed from controller 170 to amplifier 200 via MIDI I/O 184 and audio cable 204. Upon receiving the control signal from UICS 32, amplifier 200 emphasizes treble frequencies of the audio signal received from audio cable 202.

Guitarist 198 then wants amplifier 200 to deemphasize treble frequencies. Guitarist 198 contacts surface 34 in region 64a with one-finger or the guitar pick and then slides the finger toward strings 16. Touchpad 30 senses the movement of the finger along surface 34. Touchpad 30 sends electrical signals corresponding to the changing location of the finger to controller 170. Controller 170 interprets the electrical signals received from touchpad 30, recognizes that the electrical signals indicate a point of contact sliding toward strings 16 in control region 64a, and generates the control signal assigned to a point of contact sliding toward strings 16 in region 64a, i.e., a control signal instructing amplifier 200 to deemphasize treble frequencies. The control signal is routed from controller 170 to amplifier 200 via MIDI I/O 184 and audio cable 204. Upon receiving the control signal from UICS 32, amplifier 200 deemphasizes treble frequencies of the audio signal received from audio cable 202. Amplifier 200 continues to emphasize and deemphasize the treble frequencies during the duration of the slide gestures. Guitarist 198 can repeatedly emphasize and deemphasize treble frequencies by continuously sliding the finger up and down region 64a, i.e., toward and away from strings 16.

Next, guitarist 198 wants amplifier 200 to change the emphasis of bass frequencies. Guitarist 198 slides a finger over region 64b away from strings 16. Touchpad 30 senses the initial contact of the finger in control region 64b and sends an electrical signal corresponding to the point of contact being located in region 64b to controller 170. Because the initial contact is made in region 64b, controller 170 sends bass frequency control signals. As the finger moves away from strings 16, touchpad 30 sends electrical signals corresponding to the changing location of the finger to controller 170. Controller 170 interprets electrical signals from touchpad 30 and generates an emphasize bass frequencies control signal. The emphasize bass frequencies signal is sent to amplifier 200 and amplifier 200 emphasizes the bass frequencies of the audio signal.

Guitarist 198 then begins to slide the finger toward strings 16. Touchpad 30 senses that a point of contact in region 64b is moving toward strings 16. Touchpad 30 generates electrical signals corresponding to the changing xyz coordinates of the points of contact. Touchpad 30 sends the electrical signals to controller 170. Controller 170 receives the electrical signals corresponding to the finger moving toward strings 16 and outputs a deemphasize bass frequencies control signal. The deemphasize bass frequencies control signal is sent to amplifier 200 via MIDI I/O 184 and audio cable 204. Amplifier 200 receives the control signal and deemphasizes the bass frequencies of the audio signal. Amplifier 200 continues to emphasize and deemphasize the bass frequencies during the duration of the slide gestures. Guitarist 198 can repeatedly emphasize and deemphasize the bass frequencies by continuously sliding the finger up and down region 64b, i.e., toward and away from strings 16.

UICS 32 also controls a guitar and accessories coupled to the guitar by assigning a device or effect to a specific control surface. For example, in FIG. 8c, UICS 32 of guitar 100 is programmed to send control signals to pickups 126 in response to gestures performed on surface 108a, reverb control signals to DSP 174 in response to gestures performed on surface 108b, synthesize audio control signals to MIDI synthesizer 186 in response to gestures performed on surface 112a, amplification control signals to amplifier 224 in response to gestures performed on surface 116a, and effects control signals to effects box 227 in response to gestures performed on surface 122a. Guitar 100, amplifier 224, and effects box 227 are each connected to network 188. UICS 32 of guitar 100 sends control signals to amplifier 224 and effects box 227 via communication links 220 and network 188. Alternatively, amplifier 224 and effects box 227 are coupled to MIDI I/O 184. Guitarist 198 uses the different control surfaces of guitar 100 to control properties of guitar 100, amplifier 224, and effects box 227.

UICS 32 of guitar 100 is programmed to send control signals that select particular sets of pickups 126 in response to gestures performed on surface 108a. A control signal selecting a first set of pickups 126 is sent in response to a one-finger slide gesture on surface 108a. A control signal selecting a second set of pickups 126 that is different from the first set of pickups 126 is sent in response to a two-finger slide gesture. A control signal selecting a third set of pickups 126 is sent in response to a three-finger slide gesture.

Guitarist 198 wants to select the first set of pickups. Guitarist 198 performs a one-finger slide gesture on or over surface 108a of guitar 100. Control surface 108a detects two initial points of contact and senses that the points of contact are moving in a certain direction. Control surface 108a generates an electrical signal representative of the initial xyz coordinates on surface 108a. As the location of the points of contact changes, i.e., as the finger moves in the direction of the slide, control surface 108a generates electrical signals representative of the next xyz coordinates on surface 108a corresponding to the gesture. The electrical signals generated by control surface 108a are sent to controller 170. Controller 170 interprets the electrical signals received from control surface 108a, recognizes that the electrical signals indicate one-finger linear motion on surface 108a, and generates the control signal assigned to a one-finger slide gesture on surface 108a, i.e., a control signal selecting the first set of pickups 126. The control signal is routed from controller 170 to pickups 126. Upon receiving the control signal from UICS 32, the selected pickups 126 generate audio signals and the non-selected pickups cease to generate audio signals.

When guitarist 198 wants to select the second set of pickups 126, guitarist 198 performs a two-finger slide gesture on surface 108a. When guitarist 198 wants to select the third set of pickups 126, guitarist 198 performs a three-finger slide gesture on surface 108a. Guitarist 198 knows all gestures performed on surface 108a will affect pickups 126 because UICS 32 is programmed to send control signals to pickups 126 in response to gestures performed on or over surface 108a.

UICS 32 of guitar 100 is programmed to send reverb control signals to DSP 174 in response to gestures performed on or over surface 108b. An add reverb control signal is assigned to a tap on surface 108b. A remove or stop adding reverb control signal is assigned to a double tap on surface 108b. An increase reverb control signal is assigned to a one-finger slide toward bridge 114. A decrease reverb control signal is assigned to a one-finger slide away from bridge 114. An increase reverb of bass frequencies is assigned to a left-to-right arc gesture. A decrease reverb of bass frequencies is assigned to a right-to-left arc gesture. An increase reverb of treble frequencies is assigned to a clockwise circular gesture. A decrease reverb of treble frequencies is assigned to a counter-clockwise circular gesture.

Guitarist 198 wants to modify reverb of the audio signal from guitar 100. Guitarist 198 taps surface 108b with one-finger. Control surface 108b detects an initial point of contact and detects that the point of contact is removed from surface 108b. Control surface 108b generates an electrical signal representative of the initial xyz coordinates on surface 108b. The electrical signal generated by control surface 108b is sent to controller 170. Control surface 108b ceases to generate an electrical signal when the point of contact is removed. Controller 170 interprets the electrical signal and the lack of continuing electrical signals from control surface 108b, recognizes that the electrical signal indicates a tap on surface 108b, and generates the control signal assigned to a tap on surface 108b, i.e., a control signal instructing DSP 174 to add reverb. The control signal is routed from controller 170 to DSP 174. Upon receiving the control signal from controller 170, DSP 174 uses signal processing algorithms and delay circuits to add reverb to the audio signal generated by pickups 126.

After adding reverb to the audio signal, guitarist 198 wants to increase a level of the reverb being added. Guitarist 198 slides his finger toward bridge 114 to increase the level of reverb. Control surface 108b generates electrical signals representative of the finger moving along surface 108b toward bridge 114. Controller 170 interprets the electrical signals generated by control surface 108b and sends a control signal to DSP 174. The control signal instructs DSP 174 to increase a level of reverb currently being added to the audio signal. DSP 174 uses signal processing algorithms and delay circuits to increase the level of reverb in response to the control signal from controller 170.

Control surface 108b continues to send electrical signals representative of the moving point of contact to controller 170 which continues to send increase reverb control signals to DSP 174, and DSP 174 continues to increase reverb for the duration of the slide. When guitarist 198 is satisfied with the level of reverb, guitarist 198 stops performing the one-finger slide. If guitarist 198 wants to decrease the level of reverb, guitarist 198 performs a one-finger slide away from bridge 114 on surface 108b.

Next, guitarist 198 wants to adjust reverb of the bass frequencies. Guitarist performs a left-to-right arc gesture on surface 108b. Control surface 108b generates electrical signals representative of the fingers moving along surface 108b in a left-to-right arc motion. Controller 170 interprets the electrical signals generated by control surface 108b and sends the corresponding control signal to DSP 174. The control signal instructs DSP 174 to increase reverb of the bass frequencies. DSP 174 increases reverb of the bass frequencies in response to the control signal from controller 170.

Control surface 108b continues to send electrical signals representative of the moving points of contact, controller 170 continues to send increase reverb of bass control signals to DSP 174, and DSP 174 continues to increase reverb of the bass frequencies for the duration of the arc gesture. When guitarist 198 is satisfied with the level of bass frequency reverb, guitarist 198 stops performing the arc gesture. If guitarist 198 wants to decrease the level of bass frequency reverb, guitarist 198 performs a right-to-left arc gesture on surface 108b.

UICS 32 of guitar 100 is programmed to send control signals, i.e., MIDI signals, to MIDI synthesizer 186 in response to gestures performed on surface 112a, as selected by control surface selector knob 162. An add snare drum control signal is assigned to a one-finger slide toward neck 104. A remove snare drum control signal is assigned to a one-finger slide away from neck 104. An increase snare drum tempo is assigned to a pinch-open gesture. A decrease snare drum tempo is assigned to a pinch-close gesture. In one embodiment, guitarist 198 controls the tempo of the snare drum signal by tapping on surface 112a at the desired snare drum tempo, i.e., the timing between snare drum taps mimics the time between taps on surface 112a. An increase snare volume is assigned to a one-finger slide toward surface 108, and a decrease snare volume is assigned to a one-finger slide toward surface 110. An add horn melody control signal is assigned to a three-finger slide toward surface 110. A remove horn melody control signal is assigned to a three-finger slide toward surface 108.

Guitarist 198 wants to add a snare drum to the sound from guitar 100 for a particular musical number. Guitarist 198 performs a one-finger slide on surface 112a toward neck 104 followed by a tap. Control surface 112a generates electrical signals representative of the fingers moving along surface 112a toward neck 104 plus tap combination. Controller 170 interprets the electrical signals generated by control surface 112a and sends a control signal to MIDI synthesizer 186. The control signal causes MIDI synthesizer 186 to generate an audio signal representative of a snare drum. The audio signal is output to DSP 174. DSP 174 combines the audio signal from MIDI synthesizer 186 with audio signal from pickups 126 and outputs the composite audio signal. Guitarist 198 controls and adjusts the tempo of the snare drum beat by performing pinch-open and pinch-close gestures on surface 112a. Guitarist 198 controls and adjusts the volume of the snare drum beat by performing one-finger slides on surface 112a toward surface 108 and surface 110.

Guitarist 198 wants to add a horn melody to the chorus of the musical number. At the chorus, guitarist 198 performs a three-finger slide on surface 112a toward surface 110 followed by a sequential three finger tap. Control surface 112a generates electrical signals representative of the three fingers moving along surface 112a toward surface 110 and sequential three finger tap combination. Controller 170 interprets the electrical signals generated by control surface 112a and sends a control signal to MIDI synthesizer 186. The control signal causes MIDI synthesizer 186 to generate an audio signal representative of the horn melody. The audio signal is output to DSP 174. DSP 174 combines the audio signal from MIDI synthesizer 186 with audio signal from pickups 126 and the snare drum, and outputs the composite audio signal. After the chorus, guitarist 198 performs a three-finger slide on surface 112a toward surface 108 plus sequential three finger tap combination and controller 170 sends a control signal to MIDI synthesizer 186 instructing MIDI synthesizer 186 to stop generating the horn melody. Guitarist 198 knows all gestures performed on surface 112a will generate and control synthesized sounds because UICS 32 is programmed to send control signals to MIDI synthesizer 186 in response to gestures performed over surface 112a.

UICS 32 of guitar 100 is programmed to send control signals to amplifier 224 in response to gestures performed on surface 116a. An increase amplification control signal is assigned to a tap in a first area of surface 116a distal to fret board 118. A decrease amplification control signal is assigned to a tap in a second area of surface 116a proximate to fret board 118. An emphasize bass frequencies control signal is assigned to a slide across surface 116a away from fretboard 118, and deemphasize bass frequencies control signal is assigned to a slide across surface 116a toward fretboard 118. An emphasize treble frequencies control signal is assigned to a pinch-open gesture on surface 116a, and deemphasize treble frequencies control signal is assigned to a pinch-close gesture on surface 116a.

Guitarist 198 wants amplifier 224 to increase amplification. Guitarist 198 taps surface 116a in a region distal to fretboard 118. Control surface 116a generates an electrical signal representative of the finger performing a tap on a region of surface 116a distal to fretboard 118. Controller 170 interprets the electrical signal generated by control surface 116a, determines guitarist 198 is performing a tap in the region of surface 116a distal to fretboard 118, and sends a control signal to amplifier 224 via network 188. Alternatively, the control signal is sent to amplifier 224 via MIDI I/O 184. The control signal causes amplifier 224 to increase amplification of the audio signal output from amplifier 224.

Guitarist 198 wants amplifier 224 to continue to increase the amplification of the audio signal. Guitarist 198 performs additional taps on surface 116a in the region distal to fretboard 118. Each tap causes control surface 116a to generate an electrical signal corresponding to a tap in the region of surface 116a distal to neck 104. Each electrical signal, i.e., tap, causes controller 170 to send an increase amplification control signal to amplifier 224. Each control signal causes amplifier 224 to increase an amplification of the audio signal.

Guitarist 198 next wants amplifier 224 to decrease amplification of the audio signal. Guitarist 198 performs a tap on surface 116a in the region proximate to fretboard 118. Each tap performed by guitarist 198 generates an electrical signal representative of a point of contact in the region of surface 116a proximate to fretboard 118. The electrical signals are sent to controller 170. Controller 170 interprets the electrical signals and sends a decrease amplification control signal to amplifier 224 via network 188. Amplifier 224 receives the control signal and decreases amplification of the audio signal output from amplifier 224. Guitarist 198 performs taps on surface 116a in the regions proximate and distal to neck 104 until the amplification is at a desired level.

Guitarist 198 causes amplifier 224 to adjust the emphasis of bass frequencies by sliding a finger over surface 116a toward and away from neck 104. Guitarist 198 causes amplifier 224 to adjust the emphasis of treble frequencies by performing pinch-open and pinch-close gestures on surface 116a. Guitarist 198 knows all gestures performed on surface 116a will affect and control properties of amplifier 224 because UICS 32 is programmed to send control signals to amplifier 224 in response to gestures performed on or over surface 116a.

UICS 32 of guitar 100 is programmed to send control signals to effects box 227 in response to gestures performed on or over surface 122a. An add wah-wah control signal is assigned to a tap on surface 122a. Control of the wah-wah effect is assigned to pinch-open and pinch-close gestures. A boost volume of the wah-wah effect is assigned to a clockwise circular gesture. A decrease volume of the wah-wah effect is assigned to a counter-clockwise circular gesture.

Guitarist 198 wants effects box 227 to add a wah-wah effect to the audio signal from guitar 100. Guitarist 198 taps surface 122a with one-finger. Control surface 122a detects an initial point of contact and detects that the point of contact is removed from the control surface, i.e., control surface 122a detects a tap. Control surface 122a generates an electrical signal representative of the xyz coordinates on surface 122a. The electrical signal generated by control surface 122 is sent to controller 170. Control surface 122a ceases to generate an electrical signal when the point of contact is removed. Controller 170 interprets the electrical signal and the lack of continuing signal from control surface 122a and recognizes that the electrical signal indicates a tap on surface 122a. Controller 170 generates the control signal assigned to a tap on surface 122a, i.e., a control signal instructing effects box 227 to add wah-wah. The control signal is routed from controller 170 to effects box 227 via network 188. Alternatively, the control signal is routed to effects box 227 via MIDI I/O 184. Upon receiving the control signal, effects box 227 uses signal processing algorithms and other circuits to add wah-wah to the audio signal generated by guitar 100.

Guitarist 198 controls the wah-wah effect by performing pinch-open and/or pinch-close gestures on surface 122a. The pinch-close gesture causes controller 170 to send a control signal that instructs effects box 227 to boost low frequencies. The pinch-open gesture causes controller 170 to send a control signal that instructs effects box 227 to boost high frequencies. Guitarist 198 uses the pinch-open and pinch-close gestures to simulate a foot rocking or compressing a wah-wah pedal. The pinch-close gesture simulates the effect of a foot pressing on or rocking back the wah-wah pedal. The pinch-open gesture simulates the effect of a foot letting up on or rocking forward on the wah-wah pedal.

Guitarist 198 controls volume of the wah-wah effect by performing circular gestures on surface 122a. A clockwise rotation causes controller 170 to send a control signal that instructs effects box 227 to increase volume. A counter clockwise rotation causes controller 170 to send a control signal that instructs effects box 227 to decrease volume. Guitarist 198 knows all gestures performed on surface 122a will affect and control properties of effects box 227.

UICS 32 also allows a guitarist to control a guitar and accessories coupled to the guitar by performing a first gesture on a control surface to select the device or effect and then performing a second gesture to control the selected device or effect.

For example, UICS 32 of guitar 10 in FIG. 8d is programmed via control surface selector knob 162 such that a tap in region 30a sets the entire surface 34 to control volume and other tonal qualities of guitar 10, a tap in region 30b sets the entire surface 34 to control amplifier 224, a tap in region 30c sets the entire surface 34 to control effects box 227, and a tap in region 30d sets the entire surface 34 to control stage lighting 230 and fog machine 232.

Guitarist 198 wants to select a first set of pickups 26 on guitar 10. The first set of pickup is assigned to a one-finger slide toward strings 16. Guitarist 198 taps region 30a. Touchpad 30 senses a point of contact on surface 34 in region 30a. Touchpad 30 generates an electrical signal representative of the xyz coordinates on surface 34. The electrical signal generated by touchpad 30 is sent to controller 170. Controller 170 interprets the electrical signal received from touchpad 30 and recognizes that the electrical signal indicates a tap in region 30a. The tap in region 30a indicates that subsequent gestures, i.e., electrical signals from touchpad 30, will generate control signals controlling properties of guitar 10. The tap in region 30a sets touchpad 30 to control aspects of the audio signal output from guitar 10.

After tapping region 30a, guitarist 198 performs a one-finger slide toward strings 16. Touchpad 30 generates an electrical signal representative of the changing xyz coordinates on surface 34. The electrical signal generated by touchpad 30 is sent to controller 170. Controller 170 interprets the electrical signals received from touchpad 30 and recognizes that the electrical signals indicate a point of contact moving on surface 34 toward strings 16. Controller 170 generates the control signal for a point of contact moving on surface 34 toward strings 16, i.e., a control signal selecting the first set of pickups 26. The control signal is sent to pickups 26.

Guitarist 198 next wants to add and control reverb of the audio signal generated by pickups 26. Reverb control is assigned to pinch-open and pinch-close gestures. A pinch-open gesture adds/increases reverb and a pinch-close gesture removes/decreases reverb. Surface 34 is still set to guitar 10, i.e., guitarist 198 has not tapped regions 30b-30d and does not need to tap region 30a again to effect reverb which is added by DSP 174. Guitarist 198 performs pinch-open and pinch-close gestures on surface 34 to add and adjust reverb of the audio signal. Touchpad 30 generates electrical signals representative of the changing xyz coordinates on surface 34. The electrical signals generated by touchpad 30 are sent to controller 170. Controller 170 interprets the electrical signals received from touchpad 30, recognizes that the electrical signals indicate pinch-open and pinch-close gestures, and generates control signals corresponding to pinch-open and pinch-close gestures, i.e., increase and decrease reverb signals. The control signals are sent to DSP 174. Controller 170 generates reverb control signals and sends the control signals to DSP 174, because surface 34 is set to control guitar 10.

Guitarist 198 wants amplifier 224 to adjust an emphasis of bass frequencies. An increase bass frequency is assigned to a one-finger slide toward strings 16. A decrease bass frequency is assigned to a one-finger slide away from strings 16. Guitarist 198 taps region 30b of touchpad 30. Touchpad 30 senses a point of contact on surface 34 in region 30b. Touchpad 30 generates an electrical signal representative of the xyz coordinates on surface 34. The electrical signal generated by touchpad 30 is sent to controller 170. Controller 170 interprets the electrical signal received from touchpad 30 and recognizes that the electrical signal indicates a tap in region 30b. The tap in region 30b indicates that subsequent gestures, i.e., electrical signals from touchpad 30, generates control signals that are output to amplifier 224 via network 188. The tap in region 30b sets touchpad 30 to control amplifier 224.

After tapping region 30b, guitarist 198 performs a one-finger slide toward strings 16. Touchpad 30 generates an electrical signal representative of the changing xyz coordinates on surface 34. The electrical signal generated by touchpad 30 is sent to controller 170. Controller 170 interprets the electrical signals received from touchpad 30, recognizes that the electrical signals indicate a point of contact moving on surface 34 toward strings 16, and generates the control signal for a point of contact moving on surface 34 toward strings 16, i.e., a MIDI signal instructing amplifier 224 to emphasize bass frequencies. The control signal is sent to amplifier 224 via network 188 and communication links 220. Alternatively, the control signal is sent via MIDI I/O 184. The one-finger slide toward strings 16 generates an emphasize bass frequencies control signal, as opposed to a select pickups 26 control signal, because surface 34 is set to control amplifier 224, i.e., the slide was after a tap in region 30b and prior to a tap in region 30a, 30c, or 30d.

Next, guitarist 198 wants to control effects box 227 to add and control a wah-wah effect. Add wah-wah is assigned to a one-finger slide toward strings 16 and control of the wah-wah effect is assigned to a pinch-open gesture and pinch-close gesture. Guitarist 198 taps region 30c of touchpad 30. Touchpad 30 senses a point of contact on surface 34 in region 30c. Touchpad 30 generates an electrical signal representative of the xyz coordinates on surface 34. The electrical signal generated by touchpad 30 is sent to controller 170. Controller 170 interprets the electrical signal received from touchpad 30 and recognizes that the electrical signal indicates a tap in region 30c. The tap in region 30b indicates that subsequent gestures, i.e., electrical signals from touchpad 30, will generate control signals that will be output to effects box 227 via network 188. The tap in region 30c sets touchpad 30 to control effects box 227.

After tapping region 30c, guitarist 198 performs a one-finger slide toward strings 16. Touchpad 30 generates an electrical signal representative of the changing xyz coordinates on surface 34. The electrical signal generated by touchpad 30 is sent to controller 170. Controller 170 interprets the electrical signals received from touchpad 30, recognizes that the electrical signals indicate a point of contact moving on surface 34 toward strings 16, and generates the control signal for a point of contact moving on surface 34 toward strings 16, i.e., a MIDI signal instructing effects box 227 to begin adding wah-wah. The control signal is sent to effects box 227 via network 188 and communication links 220. Alternatively, the control signal is sent via MIDI I/O 184. The one-finger slide toward strings 16 generates an add wah-wah signal that is routed to effects box 227, as opposed to a select pickups 26 signal or an emphasize bass frequencies signal, because surface 34 is set to control effects box 227, i.e., the slide was after a tap in region 30c and prior to a tap in regions 30a, 30b or 30d.

Guitarist 198 next performs pinch-open and pinch-close gestures on surface 34 to adjust and control the wah-wah effect. Surface 34 is still set to control effects box 227 so guitarist 198 does not need to tap region 30c prior to performing the pinch-open and pinch-close gestures. Touchpad 30 generates electrical signals representative of the changing xyz coordinates on surface 34. The electrical signals generated by touchpad 30 are sent to controller 170. Controller 170 interprets the electrical signals received from touchpad 30, recognizes that the electrical signals indicate pinch-open and pinch-close gestures, and generates control signals corresponding to pinch-open and pinch-close gestures, i.e., boost high frequencies and boost low frequencies control signals. The control signals are sent to effects box 227. Controller 170 routes the control signals to effects box 227 because touchpad 30 is still set to control effects box 227.

Next, guitarist 198 wants to control stage lighting 230 and fog machine 232. Control surface selector knob 162 configures touchpad 30 to control stage lighting 230 and fog machine 232. A first lighting configuration selecting all red lights is assigned to a one-finger slide toward strings 16. A second lighting configuration selecting all blue lights is assigned to a one-finger slide away from strings 16. A turn on fog control signal is assigned to a three-finger slide toward strings 16.

Guitarist 198 wants to change stage lights 230 to red. Guitarist 198 taps region 30d. Touchpad 30 senses a point of contact on surface 34 in region 30d. Touchpad 30 generates an electrical signal representative of the xyz coordinates on surface 34. The electrical signal generated by touchpad 30 is sent to controller 170. Controller 170 interprets the electrical signal received from touchpad 30 and recognizes that the electrical signal indicates a tap in region 30d. The tap in region 30b indicates that subsequent gestures, i.e., electrical signals from touchpad 30, will generate control signals that will be sent to stage lighting 230 and fog machines 232 via network 188. The tap in region 30d sets touchpad 30 to control stage lights 230 and fog machine 232.

After tapping region 30d, guitarist 198 performs a one-finger slide or swipe toward strings 16. Touchpad 30 generates an electrical signal representative of the changing xyz coordinates on surface 34. The electrical signal generated by touchpad 30 is sent to controller 170. Controller 170 interprets the electrical signals received from touchpad 30, recognizes that the electrical signals indicate a point of contact moving on surface 34 toward strings 16, and generates the control signal for a point of contact moving on surface 34 toward strings 16, i.e., a control instructing red stage lights 230 to turn on. The control signal is sent to stage lighting 230 via network 188 and communication links 220. Stage lights 230 turn red. The one-finger slide toward strings 16 generates a lighting control signal because surface 34 is set to control stage lighting 230 and fog machine 232, i.e., the slide was after a tap in region 30d and prior to a tap in regions 30a-30c.

Guitarist 198 next wants to select different set of pickups 126. Guitarist performs a tap in region 30a to set touchpad 30 to control guitar 10 and performs the gesture assigned to the desired set of pickups 26. After selecting the pickups, guitarist 198 wants to start fog machine 232 and turn stage lights 230 to blue. Guitarist 198 taps region 30d to set touchpad 30 to control stage lights 230 and fog machine 232. Guitarist 198 then performs a three-finger slide toward strings 16 and a one-finger slide away from strings 16. The three-finger slide causes fog machine 232 to start producing fog and the one-finger slide causes stage lights 230 to turn blue.

Using a first gesture to select a device increases the number of gestures that can be used to modify and control the device. Any number of gestures and any number of regions can be programmed into UICS 32 and touchpad 30 to select a particular device or function. Increasing the number of devices that can be controlled with UICS 32 and touchpad 30 increases the functionality of guitar 10 and provides guitarist 198 with increased opportunities for creativity.

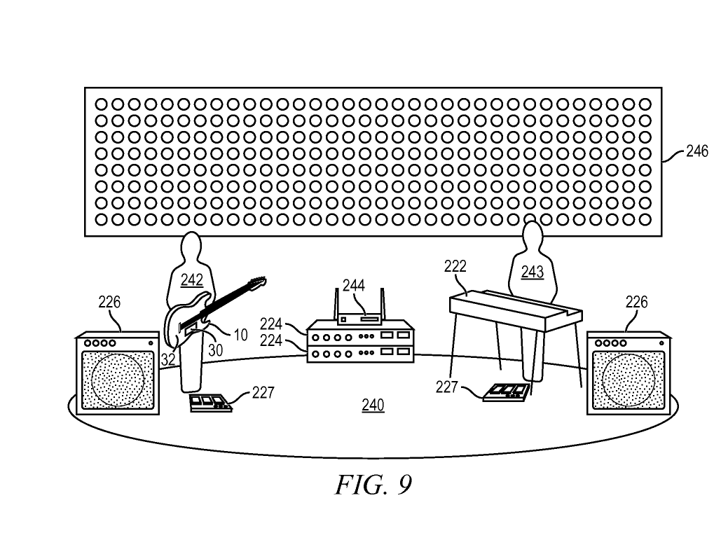

FIG. 9 illustrates an example of setting up and performing one or more musical compositions in a wireless configuration on stage 240. Guitarist 242 plays guitar 10 and musician 243 plays musical instrument 222. Audio amplifiers 224, speakers 226, effects boxes 227, and special effects unit 246 are positioned over stage 240. Wireless access point (WAP) 244 is placed near stage 240. No physical cabling is required to connect guitar 10 to musical instrument 222, audio amplifiers 224, speakers 226, effects boxes 227, or special effects unit 246. Guitar 10, devices 222-229, and special effects unit 246 are detected through WAP 244 and wirelessly connected and synced using zeroconf, universal plug and play (UPnP) protocols, Wi-Fi direct, or NFC communications. Guitarist 242 selects configuration data for guitar 10 and each of the devices 222-229 for a given musical composition using touchpad 30. The configuration data is transmitted wirelessly from guitar 10 through WAP 244 to devices 222-229. In addition to monitoring and controlling musical instrument 222 and accessories 224-229, guitar 10 and UICS 32 control special effects unit 246 during a musical performance. Control signals from guitar 10 are transmitted through communication links 220 to control special effects unit 246.

Internal memory 172 of UICS 32 on guitar 10 stores configuration data for guitar 10, musical instrument 222, accessories 224-229, and special effects unit 246. The configuration data corresponding to a particular musical composition is assigned a gesture. Before playing the musical composition, guitarist 242 performs the gesture corresponding to the configurations data for the musical composition on touchpad 30. Touchpad 30 generates electrical signal representative of the gesture and sends the electrical signals to controller 170. Controller 170 interprets the electrical signal and sends the configuration data, i.e., control signals, for each device through communications links 220. For guitar 10, the configuration data selects one or more pickups 26 as the source of the audio signal, and adjusts the volume and tonal qualities of the audio signal transmitted to audio output jack 28. For musical instrument 222, the configuration data sets the volume, balance, sequencing, tempo, mixer, tone, effects, MIDI interface, and synthesizer. For audio amplifier 224, the configuration data sets the amplification, volume, gain, filtering, tone equalization, sound effects, bass, treble, midrange, reverb dwell, reverb mix, vibrato speed, and vibrato intensity. For speaker 226, the configuration data sets the volume, and modifies bass, midrange, and treble frequencies. For effects box 227, the configuration data selects one or more sound effects to be applied to the audio signal. For effects unit 246, the configuration data selects an image, stream of images, lighting color, lasers, props, pyrotechnics, fog, or other visual and audible components.

Once guitar 10, musical instrument 222, accessories 224-229, and effects unit 246 are configured, the musical composition is played on guitar 10 and musical instrument 222. The audio signals, generated from guitar 10 and musical instrument 222, are transmitted through communication links 220 to audio amplifier 224, speaker 226, and effects box 227. Amplifier 224, speaker 226, and effects box 227 perform signal processing functions according to the configuration data and any additional control signals sent from guitar 10. Guitarist 242 can change the configurations of guitar 10, musical instrument 222, accessories 224-229, and/or effects unit 246 by performing gestures on touchpad 30. The control signal assigned to each gesture is transmitted to the internal circuitry of guitar 10, musical instrument 222, accessories 224-229, and effects unit 246 in real-time allowing guitarist 242 to change the signal processing functions or other configurations of guitar 10, musical instrument 222, accessories 224-229, and effects unit 246 anytime during the playing of the musical composition.

In addition to gestures that configure all of the devices on stage 240 simultaneously, gestures that configure the devices individually or in particular groupings are programmed into UICS 32. UICS 32 lets guitarist 242 change the configuration data of the guitar 10, musical instrument 222, accessories 224-229, and effects unit 246 independently or in groups using touchpad 30. For example, prior to playing a musical number, guitarist 242 performs a one-finger slide or swipe on touchpad 30 toward neck 14. The one-finger slide toward neck 14 generates a control signal that configures guitar 10, musical instrument 222, accessories 224-229, and effects unit 246 for the musical number about to be played.

During the musical number, guitarist 242 wants to change the configuration of guitar 10 and musical instrument 222 for chorus sections. UICS 32 is programmed to send the control signal for the chorus section configurations of guitar 10 and musical instrument 222 in response to a one-finger slide touchpad 30 away from strings 16. Just prior to the chorus sections, guitarist 242 performs a one-finger slide away from strings 16 on touchpad 30. In response to the one-finger slide away from strings 16, controller 170 outputs control signals that cause the configurations of guitar 10 and musical instrument 222 to change to the desired chorus section settings. After playing the chorus, guitarist 242 wants to return guitar 10 and musical instrument 222 to the original configurations. Guitarist 242 performs the one-finger slide toward neck 14 on touchpad 30 and guitar 10 and musical instrument 222 are returned to the original configuration.

For a guitar solo in the musical number, guitarist 242 needs to change the configurations of guitar 10 and amplifier 224 and add a sustain effect. The guitar solo configurations for guitar 10 and amplifier 224 are assigned to a pinch-open gesture on touchpad 30 and a sustain effect is assigned to a hover gesture over surface 34 of touchpad 30. Just before the solo, guitarist 242 performs the pinch-open gesture to change the configurations of guitar 10 and amplifier 224. In response to the pinch-open gesture, controller 170 sends a configuration control signal to guitar 10 and amplifier 224 and the configurations of guitar 10 and amplifier 224 are changed to the desired guitar solo configuration. During the guitar solo, guitarist 242 performs a hover gesture over touchpad 30 to add sustain to the audio signal. Touchpad 30 generates electrical signals corresponding to the hover gesture, controller 170 interprets the electrical signals corresponding to the hover gesture and sends a control signal to DSP 174. The control signal instructs DSP 174 to perform a sustain effect on the audio signal generated by pickups 26. Touchpad 30 continues to generate electrical signals representative of a point of contact above surface 34 i.e., a hover, controller 170 continues to send sustain control signals, and DSP continues to add sustain for as long as the hover gesture is detected by touchpad 30.

At the end of the guitar solo, guitarist 242 wants a pyrotechnic effect to take place. The pyrotechnic effect is assigned to a three-finger slide or swipe toward strings 16. Guitarist 242 stops performing the hover gesture at the end of the solo and immediately performs a three-finger slide toward strings 16. The three-finger slide toward strings 16 causes controller 170 to send a control signal to effects unit 246 and the pyrotechnic effect takes place. After the guitar solo, guitarist 242 returns guitar 10 and amplifier 224 to the original configuration by performing a one-finger slide toward neck 14 and finishes playing the musical number.

UICS 32 allows a guitarist to control and configure onboard devices of a guitar and external devices coupled to the guitar using a control surface. UICS 32 allows the guitarist to send control signals to a plurality of musical instruments and signal processing devices simultaneously. The guitarist controls signal processing functions to modify properties of the audio signal, add effects to the audio signal, and combine the audio signal with synthesized audio signals to create a wide selection of unique sounds. UICS 32 lets the guitarist add and synthesize different instruments to enrich the musical compositions playable from the guitar.

Control surfaces of a guitar are used to input commands into UICS 32. The location of the control surface allows the guitarist to quickly and easily perform gestures on or over the control surface while playing the guitar. The control surfaces are capable of detecting multiple xyz coordinates. The plural-point and z-axis awareness of the control surfaces increases the number of recognizable gestures. The number of recognizable gestures, the number of control surfaces, and the number of distinguishable control regions of a surface are directly related to the number of control signals that can be programmed into UICS 32. Increasing the number of recognized gestures and/or the number of control surfaces and regions increases the number of devices and functions that can be controlled from a guitar.

A guitarist can control any device configured to receive MIDI signals by performing gestures over the control surfaces. UICS 32 lets a guitarist configure and control devices connected to a communication network, e.g., network 188. The guitarist can control and modify properties of the devices wirelessly. The wireless format reduces or negates the need for physical cabling, which is expensive, prone to malfunction, not visually appealing, and limits the spacing between devices.

Modifying audio signals and controlling various musical instruments and accessories from a guitar having a control surface enables limitless creativity. The guitarist is able to explore and experiment with new sounds both during live performances and in studio. Controlling the instruments and accessories using the control surface allows the guitarist to move freely about a stage. In addition to creating sounds and performances that are acoustically interesting and appealing, UICS 32 gives a musician freedom for showmanship and increases audience enjoyment of live shows.

Guitar 10 sends and receives data signals through WAP 244 to external server 223. Any musical performance or configuration can be stored on server 223 and retrieved for later use.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of configuring and controlling a musical instrument, comprising:
providing a guitar;
disposing a control surface over the guitar;
performing a gesture with respect to the control surface;
creating a control signal in response to the gesture; and
modifying an audio signal generated by the guitar in response to the control signal.

2. The method of claim 1, further including:
providing an accessory to the guitar; and
modifying a configuration of the accessory or a configuration of the guitar in response to the control signal.

3. The method of claim 1, further including providing a control surface selector in communication with the control surface.

4. The method of claim 1, further including modifying the audio signal generated by the guitar using a digital signal processor.

5. The method of claim 1, wherein the control system sends the control signal over a network.

6. The method of claim 1, further including programming the control system to output the control signal as a musical instruments digital interface (MIDI) signal.

7. A method of configuring and controlling a musical instrument, comprising:
providing a first musical instrument including a control surface;
providing user interaction as gestures into the control surface; and
creating a control signal in response to the user interaction.

8. The method of claim 7, further including providing a control surface selector in communication with the control surface.

9. The method of claim 7, further including performing a gesture over the control surface to input the data into the control system.

10. The method of claim 7, further including:
providing an accessory to the first musical instrument; and
routing the control signal to the accessory.

11. The method of claim 10, wherein the accessory includes an amplifier, speaker, effects box, display monitor, computer, microphone, synthesizer, mobile device, or second musical instrument.

12. The method of claim 7, further including controlling stage lighting, lasers, props, pyrotechnics, fog machines, audio/video, or other special effects using the control signal.

13. The method of claim 7, wherein the control system sends the control signal over a network.

14. A musical instrument, comprising:
a stringed instrument including a control surface; and
a control system connected to the control surface of the stringed instrument responsive to gestures performed with respect to the control surface.

15. The musical instrument of claim 14, wherein the control surface includes a motion sensor, optical sensor, or proximity sensor.

16. The musical instrument of claim 14, wherein the control system generates a control signal in response to the gesture.

17. The musical instrument of claim 16, wherein the control system sends the control signal over a network.

18. The musical instrument of claim 14, further including a musical accessory coupled to the stringed instrument.

19. The musical instrument of claim 18, wherein the musical accessory includes an amplifier, speaker, effects box, display monitor, computer, microphone, synthesizer, mobile device, or other musical instrument.

20. A musical instrument, comprising a control system coupled to a control surface of the musical instrument and responsive to a gesture performed with respect to the control surface.

21. The musical instrument of claim 20, wherein the control surface includes a motion sensor, optical sensor, or proximity sensor.

22. The musical instrument of claim 21, wherein the control surface detects an xyz coordinate.

23. The musical instrument of claim 20, wherein the musical instrument is a stringed instrument.

24. The musical instrument of claim 20, further including an accessory connected to the musical instrument.

25. The musical instrument of claim 24, wherein the control system is configured to send a control signal to the accessory in response to the gesture performed on or over the control surface.
